(19) United States
(12) Patent Application Publication
(10) Pub. No.: US 2025/0193128 A1
(43) Pub. Date: Jun. 12, 2025

(54) CAPACITY ON DEMAND

(71) Applicant: CenturyLink Intellectual Property LLC, Denver, CO (US)

(72) Inventors: Scott M. Brindamour, Scituate, MA (US); Thomas C. Barnett, JR., Monroe, LA (US); Kevin M. McBride, Lone Tree, CO (US); William R. Benassi, Elk River, MN (US); Steven David Grabow, Dardenne Prairie, MO (US)

(73) Assignee: CenturyLink Intellectual Property LLC, Denver, CO (US)

(21) Appl. No.: 18/965,770

(22) Filed: Dec. 2, 2024

Related U.S. Application Data
(60) Provisional application No. 63/609,030, filed on Dec. 12, 2023.

(51) Int. Cl. H04L 47/765; H04L 41/0896

(52) U.S. Cl. CPC H04L 47/765; H04L 41/0896

(57) ABSTRACT

Novel tools and techniques are provided for implementing capacity on demand functionality. In various embodiments, a computing system may generate and present a first user interface (“UI”) to a first entity over a first network, displaying data regarding network resources assigned to the first entity and an unused amount of said network resources, and may present options in the first UI for the first entity to select and allocate at least a portion of the unused network resources. The computing system may receive, from the second entity, a request for network resources to be provisioned for a specified period. The computing system may re-assign the at least a portion of the unused network resources to the second entity for the specified period, and may re-provision the at least a portion of the unused network resources to the second entity for the specified period.

### CROSS-REFERENCE TO RELATED APPLICATIONS

This application claims the benefit of U.S. Provisional Application No. 63/609,030 filed Dec. 12, 2023, entitled “Capacity on Demand,” which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing provisioning of network services, and, particularly, to methods, systems, and apparatuses for implementing capacity on demand functionality, and, more particularly, to methods, systems, and apparatuses for implementing capacity on demand brokering functionality (including auction-based exchange, reservation, trading, resale, and/or sub-leasing functionalities, and/or the like).

### BACKGROUND

In assigning and provisioning network services to users, customers, or entities, unused network resources are typically wasted, as conventionally systems are incapable of re-assigning and/or re-provisioning network services that have already been assigned and provisioned. Due to limitations in the number or amount of network services that a service provider is able to provide, sold-out conditions are possible and likely. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components. For denoting a plurality of components, the suffixes “a” through “n” may be used, where n denotes any suitable integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on.

FIG. 1 depicts a schematic diagram illustrating an example system for implementing capacity on demand functionality, in accordance with various embodiments.

FIGS. 2A and 2B depict schematic diagrams illustrating non-limiting example resource re-allocations that occur when implementing capacity on demand functionality, in accordance with various embodiments.

FIGS. 3A-3K depict schematic diagrams illustrating various non-limiting example UIs that may be used when implementing capacity on demand functionality, in accordance with various embodiments.

FIGS. 4A-4C depict flow diagrams illustrating an example method for implementing capacity on demand functionality, in accordance with various embodiments.

FIG. 5 depicts a flow diagram illustrating another example method for implementing capacity on demand functionality, in accordance with various embodiments.

FIG. 6 depicts a block diagram illustrating an exemplary computer or system hardware architecture, in accordance with various embodiments.

### DETAILED DESCRIPTION OF CERTAIN EMBODIMENTS

### Overview

Various embodiments provide tools and techniques for implementing provisioning of network services, and, more particularly, to methods, systems, and apparatuses for implementing capacity on demand functionality.

In various embodiments, a computing system may generate and present a first user interface (“U”) to a first entity over a first network, displaying first data regarding an identified first set of network resources that is assigned to the first entity and displaying second data regarding an unused amount of the identified first set of network resources, and presenting first options in the first UI for the first entity to select and allocate a second set of network resources for use by other entities, the second set of network resources including at least a portion of the unused network resources among the identified first set of network resources. The computing system may receive, from the second entity, a request for network resources to be provisioned for a specified period. Based on a determination that at least a portion of the second set of network resources satisfies at least a portion of the requested network resources, the computing system may re-assign the at least a portion of the second set of network resources as a third set of network resources to the second entity for the specified period, and may re-provision a portion of the first set of network resources corresponding to the third set of network resources to the second entity for the specified period.

In examples, the computing system (e.g., a capacity on demand broker system, or the like) provides features to support at least one of a reservation or booking system within an edge orchestrator of a service provider for managing edge resources, an auction or bidding exchange system where the service provider sells unused edge resources, an auction or exchange system for customers to securely transfer ownership of specific periods (e.g., minutes, hours, months, etc.) of purchased resources to other customers of the service provider and future integration with composable disaggregated infrastructure systems. In some examples, the edge orchestrator is configured to allow for customers to schedule reservations against specific edge compute resources, specific edge network component resources, and/or specific edge data storage resources (collectively, “network resources”), or the like. In examples, the auction or exchange system is configured to allow customers to resell or trade reserved network resources with other customers. The exchange could be based on digital ledger technologies and may be rendered or minted similar to non-fungible assets or tokens. In some embodiments, composable disaggregated infrastructure resources may be integrated into reservation systems and/or auction or exchange systems to allow specific components that make up a bare metal machine to be utilized as network resources within auction or exchange systems, or the like. According to some embodiments, ultra long haul and/or metro fiber services or resources may be integrated into the reservation systems and/or bidding or exchange systems (in some cases, via optical transport and Ethernet access).

These and other aspects of the capacity on demand functionality are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

In an aspect, the technology relates to a method, including generating, by a computing system, a first UI; presenting, by the computing system, the first UI to a first entity over a first network, the first UI displaying first data regarding an identified first set of network resources that is assigned to the first entity and displaying second data regarding an amount of the identified first set of network resources that is unused; and presenting, by the computing system, first options in the first UI for the first entity to select and allocate a second set of network resources for use by other entities, the second set of network resources including at least a portion of the unused network resources among the identified first set of network resources. The method further includes receiving, by the computing system and from the second entity, a request for network resources to be provisioned for a specified period; based on a determination that at least a portion of the second set of network resources satisfies at least a portion of the requested network resources, re-assigning, by the computing system, the at least a portion of the second set of network resources as a third set of network resources to the second entity for the specified period; and re-provisioning a portion of the first set of network resources corresponding to the third set of network resources to the second entity for the specified period.

In some embodiments, the identified first set of network resources, the second set of network resources, and the third set of network resources include at least one of compute resources, network component resources, or data storage resources, and/or the like. In some examples, the identified first set of network resources, the second set of network resources, and the third set of network resources include at least one of network edge resources, bare metal resources, optical transport resources, network-to-network interconnect (“NNI”) resources, quality of service (“QoS”) monitoring resources, Ethernet access resources, Internet access resources, data storage resources, or composable disaggregated infrastructure resources, and/or the like. In some instances, the composable disaggregated infrastructure resources include at least one of graphics processing units (“GPUs”), non-volatile memory express (“NVMe”)-based memory devices, field programmable gate arrays (“FPGAs”), or network interface controller (“NIC”) cards, and/or the like. In some cases, the specified period includes at least one of a specified date, a specified time, or a specified duration, and/or the like. In examples, the specified duration includes one of a number of minutes, a number of hours, a number of days, a number of weeks, a number of months, or a number of years, and/or the like.

According to some embodiments, the method further includes identifying, by the computing system, the first set of network resources that is assigned to the first entity; and monitoring, by the computing system, usage of the first set of network resources. In some instances, generating the first UI includes generating, by the computing system, the first UI based on the identified first set of network resources and the monitored usage of the first set of network resources.

In some examples, the method further includes presenting, by the computing system, a second UI to a second entity over a second network, the second UI displaying second options for the second entity to request provisioning of network resources for specified periods. In some instances, receiving the request for network resources includes receiving, by the computing system and from the second entity via the second UI, the request for network resources to be provisioned for the specified period. In some cases, the computing system includes an auction-based exchange system. In examples, selecting and allocating the second set of network resources for use by other entities includes selecting the second set of network resources to be placed in a multi-user UI system for bidding by a plurality of entities who have access to the multi-user UI system for a chance to acquire access to the selected second set of network resources. In some examples, the second entity is a winner of the bidding among the plurality of entities and is provided with an opportunity to request, via the second UI that is presented to the second entity, the network resources to be provisioned.

In examples, the computing system includes a network resource reservation system. In some cases, selecting and allocating the second set of network resources for use by other entities includes selecting the second set of network resources to be marked in a multi-user UI system as being available for reservation by one or more of a plurality of entities who have access to the multi-user UI system. In some instances, the second entity is an entity among the plurality of entities who has been given a right to reserve the selected second set of network resources, and is provided with options to reserve, via the second UI that is presented to the second entity, the at least a portion of the second set of network resources.

In some examples, the computing system includes a network resource trading system. In some instances, selecting and allocating the second set of network resources for use by other entities includes selecting the second set of network resources to be marked in a multi-user UI system as being available for trading with one or more of a plurality of entities who have access to the multi-user UI system. In some cases, the second entity is an entity among the plurality of entities who has been selected by the first entity to trade other network resources for the selected second set of network resources. In some instances, the first and second UIs display network resources to be traded.

In examples, the first UI further provides management options for the first entity to manage scheduling unused capacity for at least one of auction, reservation, trade, resale, or sub-lease, and/or the like, based on at least one of high or low watermarks within available resources among the identified first set of network resources. In some instances, the management options include calendar-based scheduling management functionalities.

In some examples, re-assignment or re-provisioning of the portion of the first set of network resources to the second entity is recorded as a transaction on a distributed ledger system, wherein the transaction is converted into a non-fungible asset or token. In some cases, configuration management is tracked and recorded as transactions on the distributed ledger system.

In some embodiments, the method further includes updating, by the computing system, the first UI to present an amount of network resources among the identified first set of network resources available for use after re-assigning to the second entity; and presenting, by the computing system, the updated first UI to the first entity.

According to some embodiments, the method further includes, after the specified period, performing the following tasks: re-assigning, by the computing system, the portion of the first set of network resources corresponding to the third set of network resources to the first entity; re-provisioning, by the computing system, the re-assigned portion of the first set of network resources; updating, by the computing system, the first UI to present an amount of network resources among the identified first set of network resources available for use after re-assigning the portion of the first set of network resources back to the first entity; and presenting, by the computing system, the updated first UI to the first entity.

In another aspect, the technology relates to a system may include a computing system, which may include at least one first processor and a first non-transitory computer readable medium communicatively coupled to the at least one first processor. The first non-transitory computer readable medium may have stored thereon computer software including a first set of instructions that, when executed by the at least one first processor, causes the computing system to: identify a first set of network resources that are assigned to a first entity; monitor usage of the first set of network resources; generate a first UI based on the identified first set of network resources and the monitored usage of the first set of network resources; present the first UI to the first entity over a first network, the first UI displaying first data regarding the identified first set of network resources and displaying second data regarding an amount of the identified first set of network resources that is unused; presenting, by the computing system, first options in the first UI for the first entity to select and allocate a second set of network resources for use by other entities, the second set of network resources including at least a portion of the unused network resources among the identified first set of network resources; and after re-assigning and re-provisioning at least a portion of the second set of network resources to a second entity for a specified period that is set by the second entity, performing the following tasks: updating the first UI to present an amount of network resources among the identified first set of network resources available for use after re-assigning the at least a portion of the second set of network resources to the second entity for the specified period; and presenting the updated first UI to the first entity.

According to some embodiments, the first UI further provides management options for the first entity to manage scheduling unused capacity for at least one of auction, reservation, trade, resale, or sub-lease, based on at least one of high or low watermarks within available resources among the identified first set of network resources. In some cases, the management options include calendar-based scheduling management functionalities.

In some embodiments, the first set of instructions, when executed by the at least one first processor, further causes the computing system to: after the specified period, perform the following tasks: re-assigning the at least a portion of the second set of network resources to the first entity; re-provisioning the re-assigned at least a portion of the second set of network resources; updating the first UI to present an amount of network resources among the identified first set of network resources available for use after re-assigning the at least a portion of the second set of network resources back to the first entity; and presenting the updated first UI to the first entity.

In yet another aspect, the technology relates to a method, including providing, by a computing system, a UI to each user among a plurality of users, the UI displaying options for auctioning, reserving, trading, reselling, or sub-leasing unused capacity in the form of unused network resources; brokering, by the computing system, exchanges of unused network resources among two or more users among the plurality of users; re-assigning and re-provisioning, by the computing system, the exchanged unused network resources based on the brokering; and updating, by the computing system, a distributed ledger system with transactions based on at least one of the brokered transactions or re-assignment and re-provisioning of the exchanged unused network resources.

In some embodiments, the computing system includes at least one of an orchestrator, an auction-based exchange system, a network resource reservation system, a network resource trading system, a network resource resale system, a network resource sub-leasing system, a server, a cloud computing system, or a distributed computing system, and/or the like.

According to some embodiments, the unused network resources include at least one of compute resources, network component resources, or data storage resources, and/or the like. In some instances, the compute resources include compute-based composable disaggregated infrastructure resources including at least one of GPUs or FPGAs, and/or the like. In some cases, the network component resources include at least one of network edge resources, bare metal resources, optical transport resources, NNI resources, QoS monitoring resources, Ethernet access resources, Internet access resources, or network-based composable disaggregated infrastructure resources, and/or the like. In some examples, the network-based composable disaggregated infrastructure resources include NIC cards, and/or the like. In examples, the data storage resources include at least one data storage resources or data storage-based composable disaggregated infrastructure resources, and/or the like. In some instances, the data storage-based composable disaggregated infrastructure resources include NVMe-based memory devices, and/or the like.

In still another aspect, the technology relates to a method, including: identifying, by the computing system, a first set of network resources that are assigned to a first entity; monitoring, by the computing system, usage of the first set of network resources; generating, by the computing system, a first UI based on the identified first set of network resources and the monitored usage of the first set of network resources; presenting, by the computing system, the first UI to the first entity over a first network, the first UI displaying first data regarding the identified first set of network resources and displaying second data regarding an amount of the identified first set of network resources that is unused; presenting, by the computing system, first options in the first UI for the first entity to select and allocate a second set of network resources for use by other entities, the second set of network resources including at least a portion of the unused network resources among the identified first set of network resources; presenting, by the computing system, a second UI to a second entity over a second network, the second UI displaying second options for the second entity to request provisioning of network resources for specified periods; receiving, by the computing system and from the second entity via the second UI, a request for network resources to be provisioned for a specified period; determining, by the computing system, whether the second set of network resources satisfies at least a portion of the requested network resources; based on a determination that at least a portion the second set of network resources satisfies at least a portion of the requested network resources, re-assigning, by the computing system, the at least a portion of the second set of network resources as a third set of network resources to the second entity for the specified period; re-provisioning a portion of the first set of network resources corresponding to the third set of network resources to the second entity for the specified period; updating, by the computing system, the first UI to present an amount of network resources among the identified first set of network resources available for use after re-assigning to the second entity; and presenting, by the computing system, the updated first UI to the first user.

Various modifications and additions can be made to the embodiments discussed without departing from the scope of the invention. For example, while the embodiments described above refer to particular features, the scope of this invention also includes embodiments having different combination of features and embodiments that do not include all of the above-described features.

### Specific Exemplary Embodiments

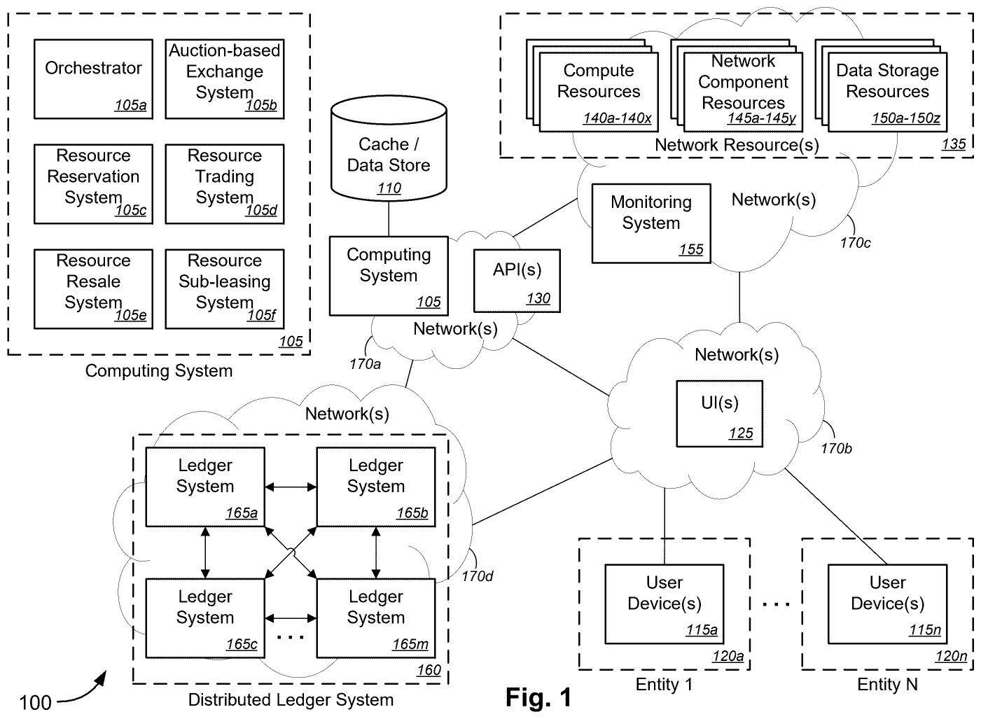

We now turn to the embodiments as illustrated by the drawings. FIGS. 1-6 illustrate some of the features of the method, system, and apparatus for implementing provisioning of network services, and, more particularly, to methods, systems, and apparatuses for implementing capacity on demand functionality, as referred to above. The methods, systems, and apparatuses illustrated by FIGS. 1-6 refer to examples of different embodiments that include various components and steps, which can be considered alternatives or which can be used in conjunction with one another in the various embodiments. The description of the illustrated methods, systems, and apparatuses shown in FIGS. 1-6 is provided for purposes of illustration and should not be considered to limit the scope of the different embodiments.

With reference to the figures, FIG. 1 depicts a schematic diagram illustrating an example system 100 for implementing capacity on demand functionality, in accordance with various embodiments. In the non-limiting example of FIG. 1, system 100 includes computing system 105 and cache and/or data store 110. System 100 further includes one or more user devices 115a-115n (collectively, “user devices 115”) that are associated with corresponding one or more entities 1 through N 120a-120n (collectively, “entities 120”), one or more user interfaces (“UIs”) 125, one or more application programming interfaces (“APIs”) 130, and network resources 135. In examples, network resources 135 include one or more of compute resources 140a-140x (collectively, “compute resources 140”), network component resources 145a-145y (collectively, “network component resources 145”), or data storage resources 150a-150z (collectively, “data storage resources 150”), and/or the like.

System 100 may further include monitoring system 155 and distributed ledger system 160, the distributed ledger system 160 including a plurality of ledger systems 165a-165m (collectively, “ledger systems 165”). Herein, m, n, x, y, and z are non-negative integer numbers that may be either all the same as each other, all different from each other, or some combination of same and different (e.g., one set of two or more having the same values with the others having different values, a plurality of sets of two or more having the same value with the others having different values, etc.). The distributed ledger system 160 is a digital system that records transaction of assets (in this case, the network resource assignment, provisioning, ownership, and/or the like) where the records (or digital ledgers) are replicated, shared, and synchronized across a majority, if not all, of the ledger systems across the distributed ledger system. In some examples, the distributed ledger system 160 is implemented using blockchain technology. Where distributed ledger systems can vary in its transparency, permissions, and use of encryption, blockchains are universally encrypted, typically using a cryptographic hash function or the like. In this manner, transparency and decentralization of the records may be achieved, and, depending on the settings of the distributed ledger system, security of the records may also be achieved.

In some embodiments, the computing system 105, the cache and/or data store 110, the one or more user devices 115a-115n, the UI(s) 125, the API(s) 130, the network resources 135 (including the one or more compute resources 140a-140x, the network component resources 145a-145y, and/or the data storage resources 150a-150z), the monitoring system 155, and the distributed ledger system 160 (including the plurality of ledger systems 165a-165m) may be disposed in network(s) 170, which may include network(s) 170a-170d. In examples, some of these components of system 100 may be disposed or located in some portion of network(s) 170a-170d, while other components may be disposed or located in other portions of network(s) 170a-170d, as shown, e.g., in FIG. 1.

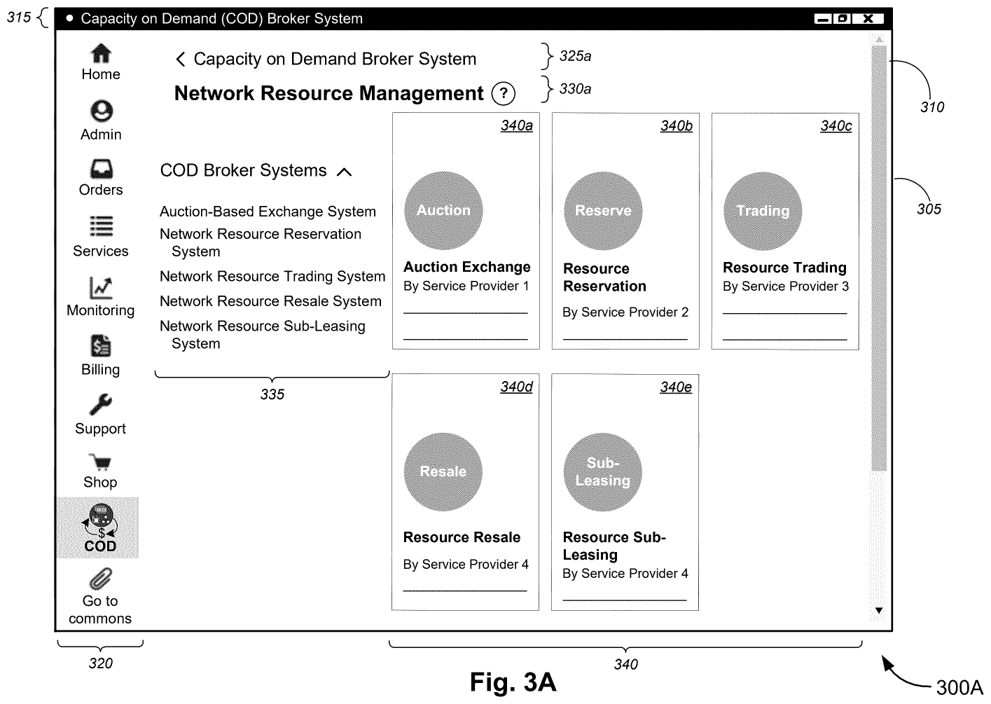

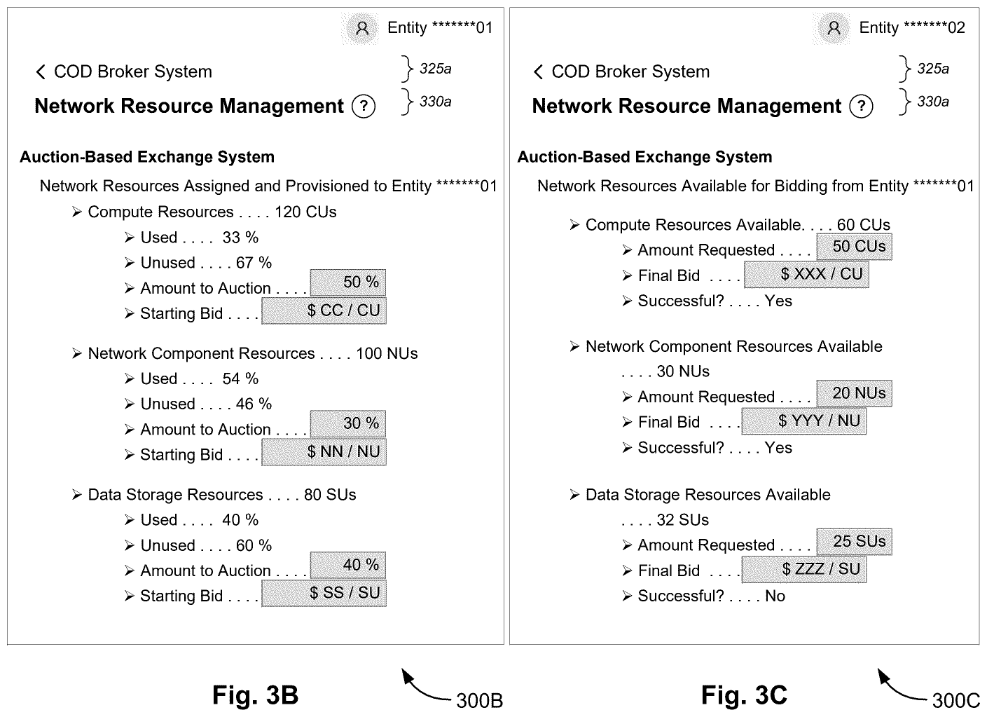

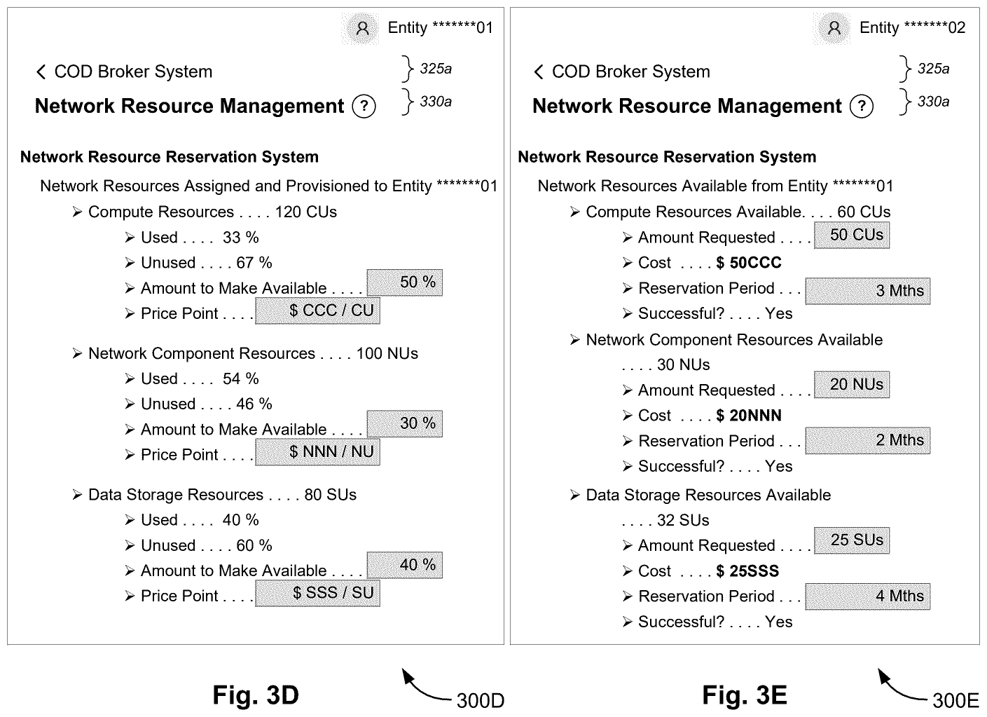

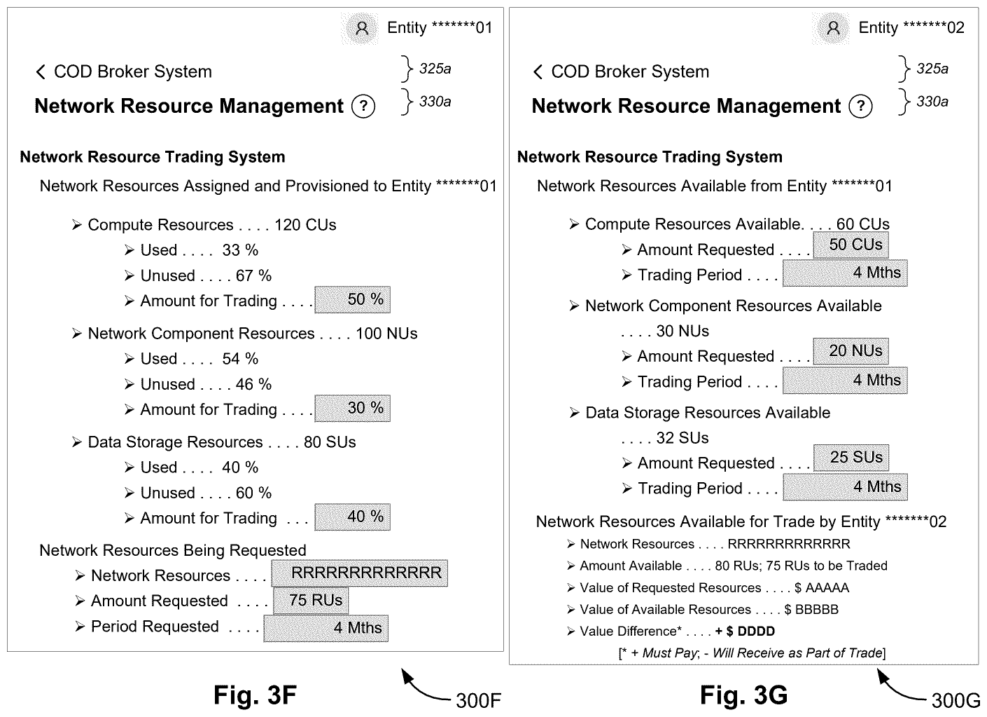

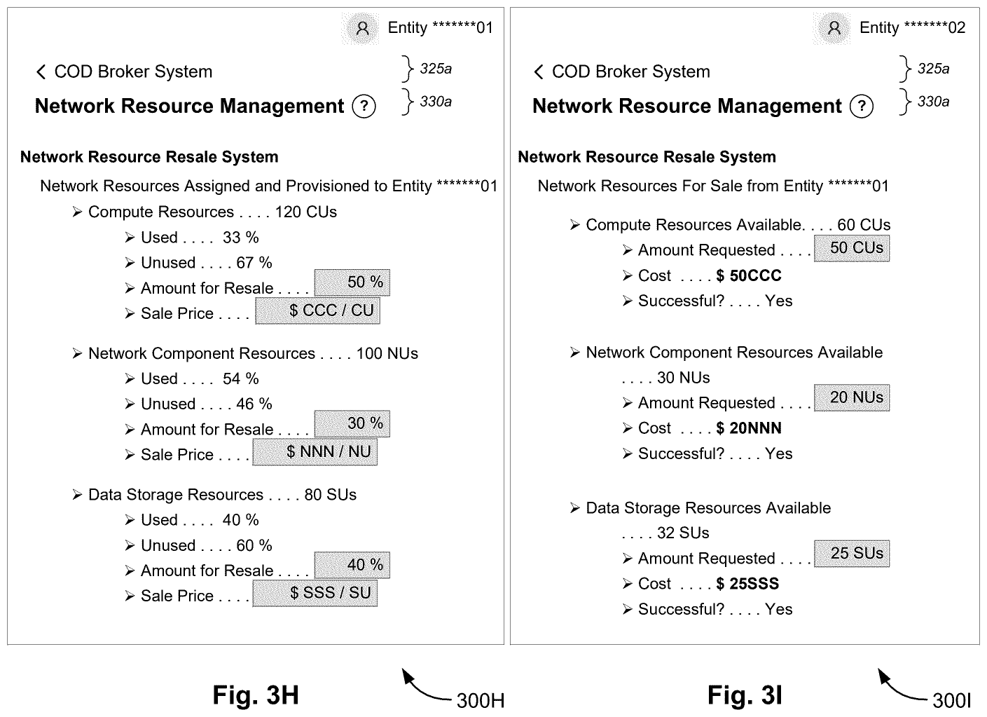

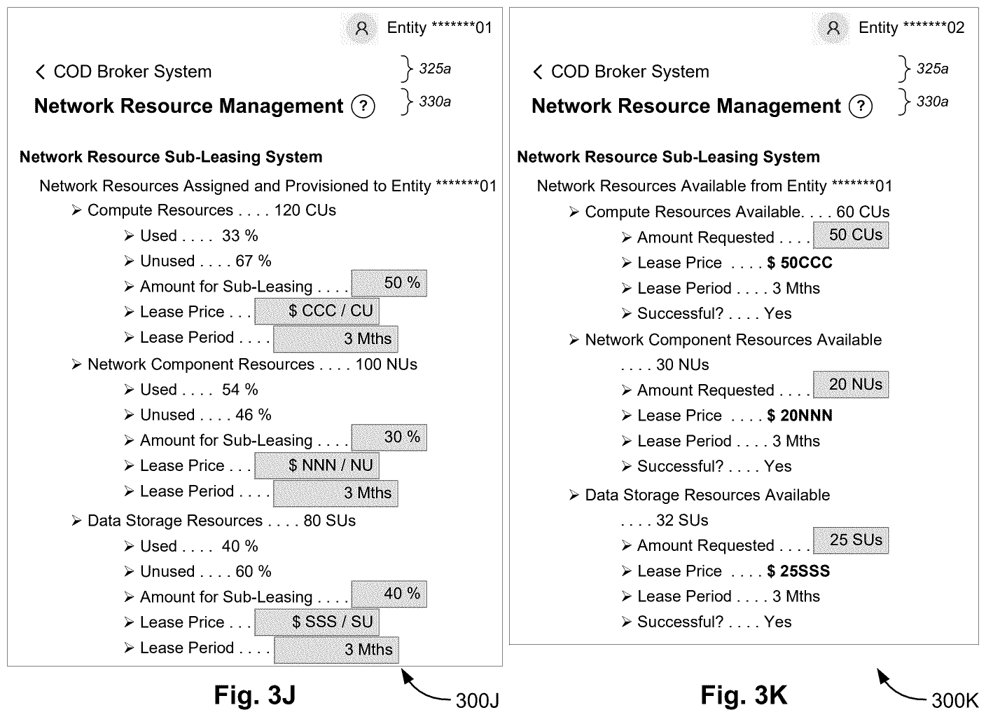

In examples, the computing system 105 includes at least one of an orchestrator 105a, an auction-based exchange system 105b, a resource reservation system 105c, a resource trading system 105d, a resource resale system 105e, a resource sub-leasing system 105f, a server, a cloud computing system, or a distributed computing system, and/or the like. The orchestrator 105a is configured to orchestrate, handle, and manage network functionalities for re-assigning and re-provisioning the network resources 135 among the one or more entities 120a-120n. In FIGS. 3B-3K, example UIs of the auction-based exchange system 105b (example UIs 300B and 300C of FIGS. 3B and 3C), the resource reservation system 105c (example UIs 300D and 300E of FIGS. 3D and 3E), the resource trading system 105d (example UIs 300F and 300G of FIGS. 3F and 3G), the resource resale system 105e (example UIs 300H and 300I of FIGS. 3H and 3I), and the resource sub-leasing system 105f (example UIs 300J and 300K of FIGS. 3J and 3K) are depicted to illustrate the types of information that are displayed or presented in UIs for these various types of systems 105b-105f as well as the types of input fields that are provided for users or entities to provide user input or information for managing network resource or capacity on demand brokering functionalities. These example UIs 300A-300K are merely for illustration purposes, and are not intended to limited the scope of the various embodiments.

In some instances, the one or more user devices 115a-115n may each include one of a desktop computer, a laptop computer, a tablet computer, a smart phone, a mobile phone, a network operations center (“NOC”) computing system or console, or any suitable device capable of communicating with network(s) 170 or with servers or other network devices within network(s) 170, or via any suitable device capable of communicating with at least one of the computing system 105, the monitoring system 155, and/or the distributed ledger system 160, and/or the like, via an API (e.g., API(s) 130, or the like), a software application (“app”), a server, a web-based portal, a UI (e.g., UI(s) 125, or the like), or any other suitable communications interface, or the like (not shown), over network(s) 170. In some cases, the one or more user devices 115a-115n may be associated with corresponding one or more entities 120a-120n, which may each include one of an individual, a group of individuals, a private company, a group of private companies, a public company, a group of public companies, an institution, a group of institutions, an association, a group of associations, a governmental agency, a group of governmental agencies, or any suitable entity or their agent(s), representative(s), owner(s), and/or stakeholder(s), or the like.

In some examples, the network resources 135 include at least one of network edge resources, bare metal resources, optical transport resources, network-to-network interconnect (“NNI”) resources, quality of service (“QoS”) monitoring resources, Ethernet access resources, Internet access resources, data storage resources, or composable disaggregated infrastructure resources, and/or the like. In examples, the composable disaggregated infrastructure resources include at least one of graphics processing units (“GPUs”), non-volatile memory express (“NVMe”)-based memory devices, field programmable gate arrays (“FPGAs”), or network interface controller (“NIC”) cards, and/or the like. In some instances, the one or more compute resources 140a-140x may include compute-based composable disaggregated infrastructure resources including at least one of GPUs or FPGAs, and/or the like. In some cases, the network component resources 145a-145y include at least one of network edge resources, bare metal resources, optical transport resources, NNI resources, QoS monitoring resources, Ethernet access resources, Internet access resources, or network-based composable disaggregated infrastructure resources, and/or the like. In some examples, the network-based composable disaggregated infrastructure resources include NIC cards, and/or the like. In examples, the data storage resources 150a-150z include at least one data storage resources or data storage-based composable disaggregated infrastructure resources, and/or the like. In some instances, the data storage-based composable disaggregated infrastructure resources include NVMe-based memory devices, and/or the like.

According to some embodiments, network(s) 170 may each include one of a local area network (“LAN”), including a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including a network operating under any of the IEEE 802.11 suite of protocols, the Bluetooth™ protocol known in the art, and/or any other wireless protocol; and/or any combination of these and/or other networks. In a particular embodiment, the network(s) 170 may include an access network of the service provider (e.g., an Internet service provider (“ISP”)). In another embodiment, the network(s) 170 may include a core network of the service provider and/or the Internet.

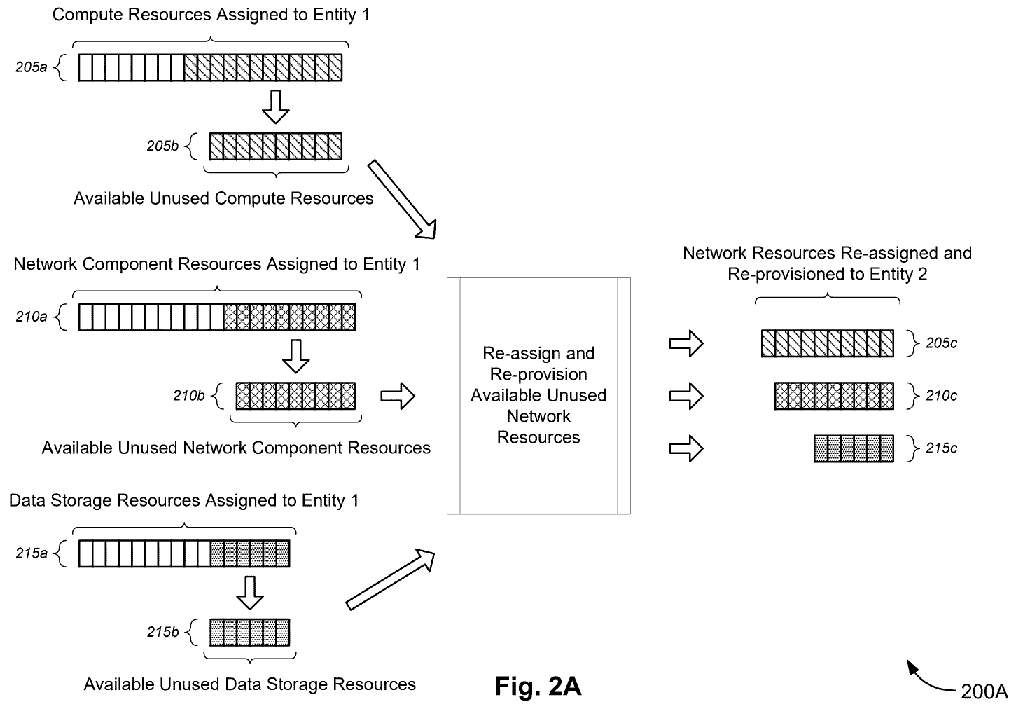

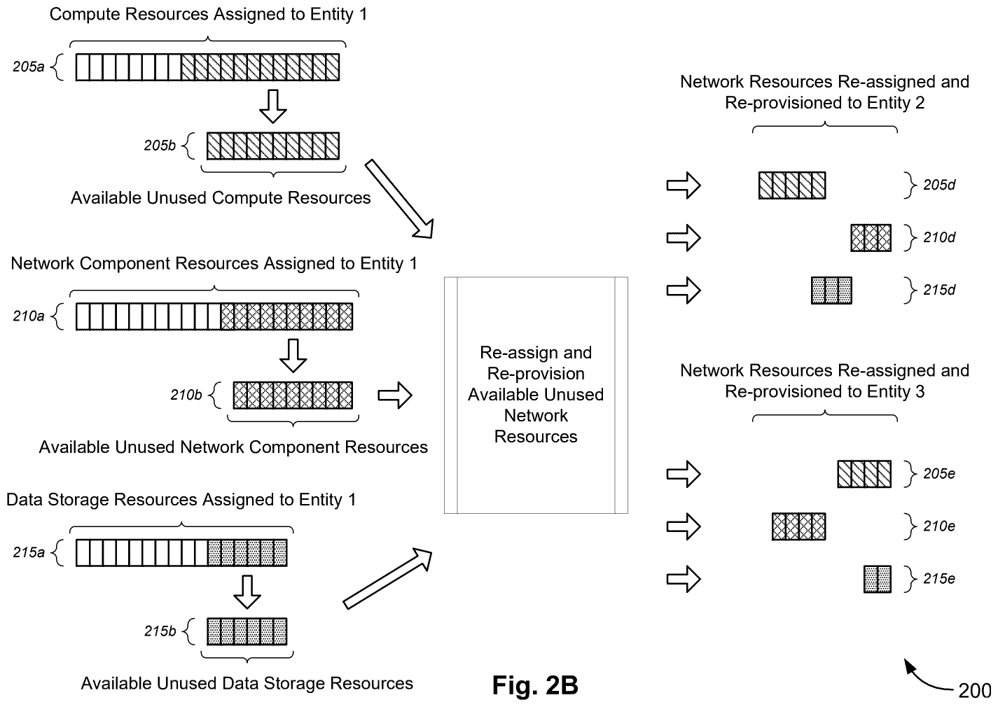

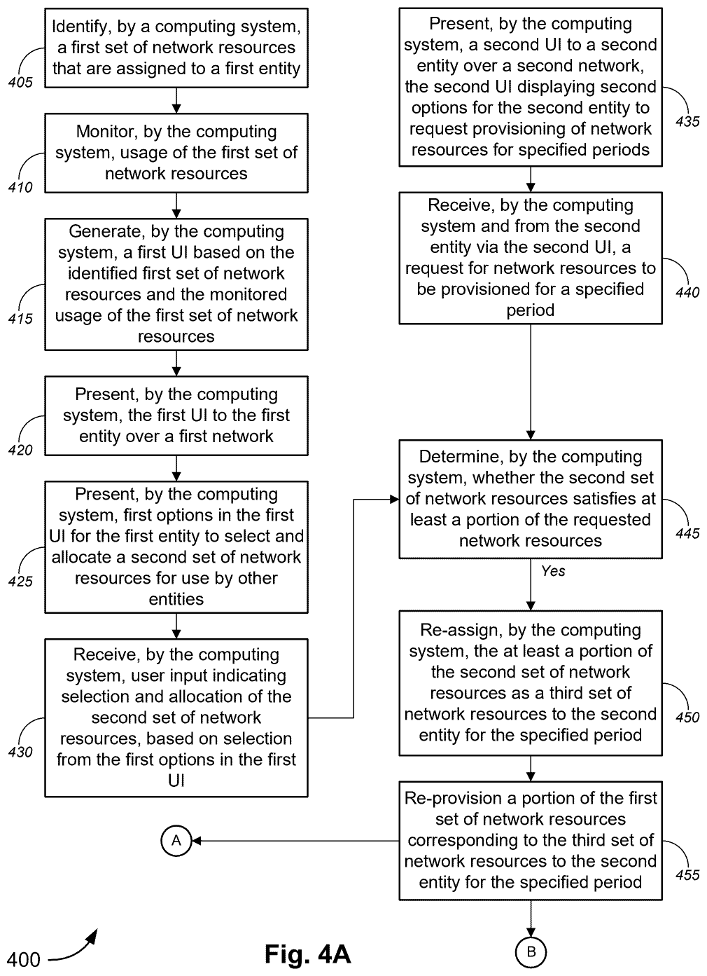

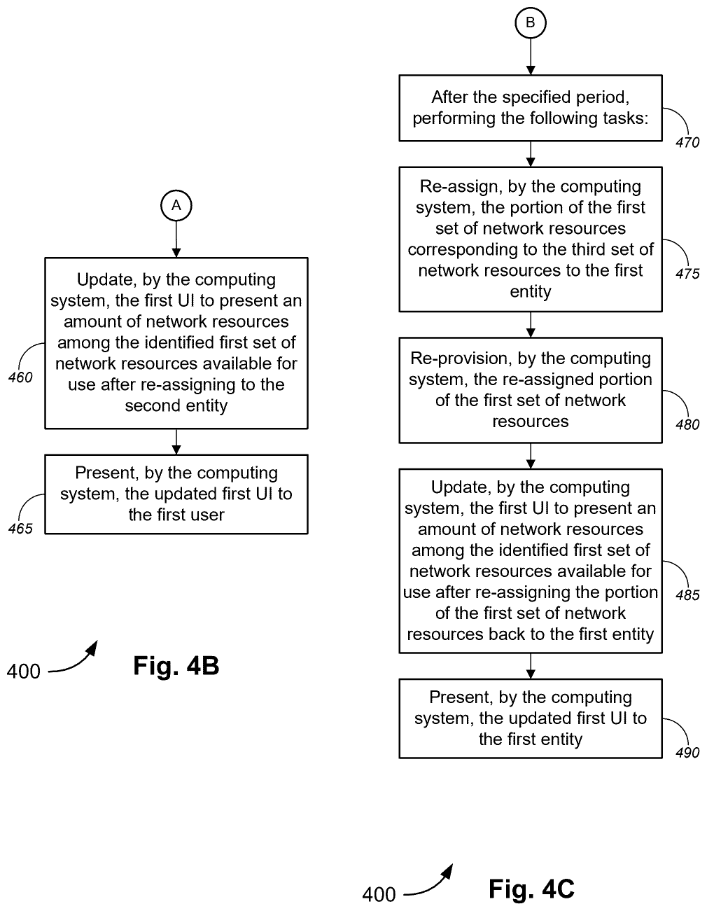

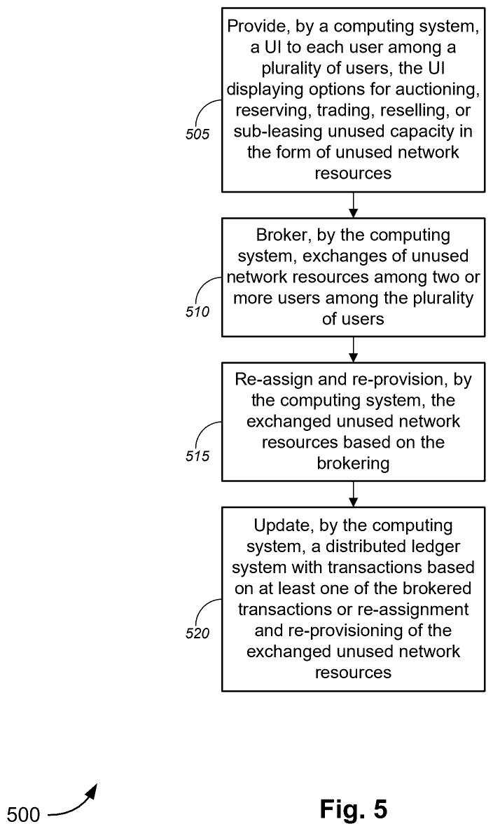

In operation, computing system 105, orchestrator 105a, auction-based exchange system 105b, resource reservation system 105c, resource trading system 105d, resource resale system 105e, resource sub-leasing system 105f, and/or monitoring system 155 (collectively, “broker system” or “capacity on demand broker system”) may perform methods for implementing capacity on demand functionality, as described in detail with respect to FIGS. 2-5. For example, FIGS. 2A and 2B are directed to example resource re-allocations 200A and 200B implementing capacity on demand functionality, while FIGS. 3A-3K are directed to example UIs 300A-300K for implementing capacity on demand functionality. FIGS. 4A-4C and 5 are directed to example methods 400 and 500 for implementing capacity on demand functionality.

FIGS. 2A and 2B (collectively, “FIG. 2”) depict schematic diagrams illustrating non-limiting example resource re-allocations 200A and 200B that occur when implementing capacity on demand functionality, in accordance with various embodiments. FIG. 2A depicts re-assigning and re-provisioning of available network resources from one entity to one other entity, while FIG. 2B depicts re-assigning and re-provisioning of available network resources from one entity to multiple other entities. In some embodiments, one or more compute resources 205a-205e, network component resources 210a-210e, and data storage resources 215a-215e of FIG. 2 may be similar, if not identical, to the one or more compute resources 140a-140x, the network component resources 145a-145y, and the data storage resources 150a-150z, respectively, of system 100 of FIG. 1, and the description of these components of system 100 of FIG. 1 are similarly applicable to the corresponding components of FIG. 2. Herein, the rectangular blocks depicted in FIG. 2 are merely used for illustration, and the network resources (represented in FIG. 2 by compute resources 205a-205e, network component resources 210a-210e, and data storage resources 215a-215e), despite being represented by adjacent rectangular blocks, may be in the same types of network resources or different types of network resources and may be located in the same part of the network or the same location or may be located throughout different parts of one or more networks and/or one or more locations. Further, unused network resources may be physically part of the same network node (e.g., server, etc.) as used network resources, or may be physically separate.

With reference to the non-limiting example resource re-allocations 200A and 200B of FIGS. 2A and 2B, compute resources 205a may be initially assigned to Entity 1 (e.g., one of the one or more entities 120a-120n of FIG. 1, or the like), the compute resources 205a including used compute resources (denoted in FIGS. 2A and 2B by blank rectangular blocks) and unused compute resources (denoted in FIGS. 2A and 2B by diagonally hatched rectangular blocks). Similarly, network component resources 210a may be initially assigned to Entity 1, the network component resources 210a including used network component resources (denoted in FIGS. 2A and 2B by blank rectangular blocks) and unused network component resources (denoted in FIGS. 2A and 2B by cross-hatched rectangular blocks). Likewise, data storage resources 215a may be initially assigned to Entity 1, the data storage resources 205a including used data storage resources (denoted in FIGS. 2A and 2B by blank rectangular blocks) and unused data storage resources (denoted in FIGS. 2A and 2B by shaded rectangular blocks). Entity 1 may select via a first UI (e.g., UI(s) 125 of FIG. 1 or UIs 300B, 300D, 300F, 300H, and 300J of FIGS. 3B, 3D, 3F, 3H, and 3J, or the like) which type of (as well as what amount of) network resources to make available for auctioning, reservation, trading, resale, and/or sub-leasing, as denoted in FIGS. 2A and 2B by diagonally hatched rectangular blocks representing available unused compute resources 205b, cross-hatched rectangular blocks representing available unused network component resources 210b, and shaded rectangular blocks representing available unused data storage resources 215b.

Referring to the non-limiting example resource re-allocation 200A of FIG. 2A, Entity 2 (e.g., another one of the one or more entities 120a-120n of FIG. 1, or the like), may select via a second UI (e.g., UI(s) 125 of FIG. 1 or UIs 300C, 300E, 300G, 300I, and 300K of FIGS. 3C, 3E, 3G, 3I, and 3K, or the like) which type of (as well as what amount of) network resources to request to bid upon, to reserve, to trade for, to purchase, and/or to sub-lease, for a specified period (e.g., a number of minutes, a number of hours, a number of days, a number of weeks, a number of months, or a number of years, etc.). If successful, the system (e.g., computing system 100 of FIG. 1, or the like) will re-assign and re-provision, from Entity 1 to Entity 2, an amount of the available unused network resources among the available unused compute resources 205b, the available unused network component resources 210b, and/or the available unused data storage resources 215b that were requested by Entity 2, as denoted by diagonally hatched rectangular blocks representing available unused compute resources 205c, cross-hatched rectangular blocks representing available unused network component resources 210c, and shaded rectangular blocks representing available unused data storage resources 215c.

Turning to the non-limiting example resource re-allocation 200B of FIG. 2B, multiple entities, in this case Entities 2 and 3 (e.g., other ones of the one or more entities 120a-120n of FIG. 1, or the like), may each select via an instance of the second UI (e.g., UI(s) 125 of FIG. 1 or UIs 300C, 300E, 300G, 300I, and 300K of FIGS. 3C, 3E, 3G, 3I, and 3K, or the like) which type of (as well as what amount of) network resources to request to bid upon, to reserve, to trade for, to purchase, and/or sub-lease. If successful, the system (e.g., computing system 100 of FIG. 1, or the like) will re-assign and re-provision, from Entity 1 to each of Entities 2 and 3, an amount of the available unused network resources among the available unused compute resources 205b, the available unused network component resources 210b, and/or the available unused data storage resources 215b that were requested by each of Entities 2 and 3, as denoted by diagonally hatched rectangular blocks representing available unused compute resources 205d and 205e, cross-hatched rectangular blocks representing available unused network component resources 210d and 210e, and shaded rectangular blocks representing available unused data storage resources 215d and 215e. As shown in FIG. 2B, each entity may request (and may ultimately be re-assigned and re-provisioned with) a portion of each of the different types of available unused network resources 205b, 210b, and 215c, rather than all of the available unused network resources (as shown in the example of FIG. 2A). Although two requesting entities are shown in FIG. 2B, any suitable number of requesting entities (not limited to two) may request and, if successful, may ultimately be re-assigned and re-provisioned with the requested network resources that were assigned and provisioned to the first entity.

These and other functions of the examples 200A and 200B (and their components) are described in greater detail herein with respect to FIGS. 1 and 3-5.

FIGS. 3A-3K (collectively, “FIG. 3”) depict schematic diagrams illustrating various non-limiting example UIs 300A-300K that may be used when implementing capacity on demand functionality, in accordance with various embodiments. FIG. 3A depicts an example UI 300A that displays or presents a main page or splash page for users or entities (e.g., the one or more entities 120a-120n of FIG. 1, or the like) to manage network resources on a capacity on demand broker system. FIGS. 3B, 3D, 3F, 3H, and 3J depict example UIs 300B, 300D, 300F, 300H, and 300J, respectively, for a first user or entity (e.g., one of the one or more entities 120a-120n of FIG. 1, or the like; in this case “Entity *******01”) to manage network resources that have been assigned or provisioned to them for auctioning, reservation, trading, resale, and/or sub-leasing to or by other entities. FIGS. 3C, 3E, 3G, 3I, and 3K depict example UIs 300C, 300E, 300G, 300I, and 300K, respectively, for a second user or entity (e.g., another one of the one or more entities 120a-120n of FIG. 1, or the like; in this case “Entity *******02”) to request at least some of the available unused network resources (that are assigned and provisioned to the first user or entity) to bid upon, to reserve, to trade for, to purchase, and/or to sub-lease, for a specified period (e.g., a number of minutes, a number of hours, a number of days, a number of weeks, a number of months, or a number of years, etc.). In some embodiments, UIs 300A-300K of FIG. 3 may be similar, if not identical, to the UI(s) 125 of system 100 of FIG. 1, and the description of these components of system 100 of FIG. 1 are similarly applicable to the corresponding components of FIG. 3.

The example UIs 300A-300K as represented in FIG. 3 are merely illustrative and are not intended to limit the scope of the various embodiments. In addition, any suitable user device—including one or more user devices 115a-115n of FIG. 1, which may each include one of a desktop computer, a laptop computer, a tablet computer, a smart phone, a mobile phone, a NOC computing system or console, or any suitable device capable of communicating with computing system 105, network resources 135, monitoring system 155, and/or distributed ledger system 160, or the like, via a web-based portal, an API (e.g., API(s) 130, or the like), a server, an app, or any other suitable communications interface, or the like, over network(s) 170a-170d of FIG. 1, and the like—may be used to display or present the UIs 300A-300K of FIG. 3.

As shown in the embodiment of FIG. 3A, display or display screen 305 (which may be a touchscreen display or a non-touchscreen display) may display or present an app, an application window, a program window, or a portal (e.g., a web portal or the like) (collectively, “app or portal 310” or the like). In the non-limiting example of FIG. 3A, the app or portal 310 running on the user device may be a UI 300A illustrating a network resource management interface for a capacity on demand broker system, or the like, although the various embodiments are not limited to such an app or portal, as described herein, and can be any suitable app or portal. The app or portal 310 displayed in display 305 may provide a user (e.g., a technician, a service provider agent, or other representative, etc. of the service provider, and/or a customer, a user, an entity (e.g., the entities as described above with respect to FIGS. 1, 2A, and 2B, or the like), or an agent of an entity, etc.) with the ability, functionality, or options to manage network resources for network resources (e.g., the one or more compute resources 140a-140x, the network component resources 145a-145y, and/or the data storage resources 150a-150z, or the like) that have been assigned or provisioned to a first entity for auction, reservation, trading, resale, and/or sub-leasing to or by one or more second entities.

As shown in the non-limiting example of FIG. 3A, the app or portal 310 may include at least one of a header portion 315 (e.g., indicating the app or portal site as “Capacity on Demand (COD) Broker System” or the like) and/or a navigation portion 320 (including icons or links for navigating to aspects or sections of the broker system or, more generally, to aspects or sections of a user-side or customer-facing portal for managing network services and/or products), and/or the like. In some cases, such as shown, e.g., in FIG. 3A, the icons or links of the navigation portion 320 may include at least one of a home icon or link (which, when depressed, clicked, or activated, may link or navigate to a home page or landing page that is tailored for the user and/or the entity, or the like), an admin icon or link (which, when depressed, clicked, or activated, may link or navigate to an administration page for displaying administration options for the account(s) of the user or the entity, or the like), an orders icon or link (which, when depressed, clicked, or activated, may link or navigate to an orders page for managing orders of services and/or products, or the like), a services icon or link (which, when depressed, clicked, or activated, may link or navigate to a service management page for displaying management options for ordered services and/or products, or the like), a monitoring icon or link (which, when depressed, clicked, or activated, may link or navigate to a monitoring page for managing collection of, monitoring, and/or displaying metrics for ordered services and/or products, or the like), a billing icon or link (which, when depressed, clicked, or activated, may link or navigate to a billing page for displaying billing information for ordered services and/or products, or the like), a support icon or link (which, when depressed, clicked, or activated, may link or navigate to a support page for providing resources and contact information for seeking assistance with ordered services or products or with ordering new services or products, or the like), a shop icon or link (which, when depressed, clicked, or activated, may link or navigate to a shopping page for ordering new services and/or products, or the like), a capacity on demand (“COD”) icon or link (which, when depressed, clicked, or activated, may link or navigate to a capacity on demand manager page for managing capacity on demand broker functionalities such as shown in FIGS. 3A-3K, or the like), or a “Go to commons” icon or link (which, when depressed, clicked, or activated, may link or navigate to a jump page for navigating to other pages or services, or the like), and/or the like.

Turning to the non-limiting example of FIG. 3A, the app or portal 310 may further include at least one of a section header portion 325a (e.g., indicating that a subpage of the capacity on demand broker system is being displayed, with a link that, when depressed, clicked, or activated, may return the user to the capacity on demand broker system main page, or the like), a title portion 330a (e.g., indicating “Network Resource Management” page, or the like), a categories portion 335, and an app tile portion 340, and/or the like. In examples, the categories portion 335 may include a list of categories of capacity on demand broker systems, including an auction-based exchange system (e.g., auction-based exchange system 105b of FIG. 1, or the like), a resource reservation system (e.g., resource reservation system 105c of FIG. 1, or the like), a resource trading system (e.g., resource trading system 105d of FIG. 1, or the like), a resource resale system (e.g., resource resale system 105e of FIG. 1, or the like), and/or a resource sub-leasing system (e.g., resource sub-leasing system 105f of FIG. 1, or the like), and/or the like. In some examples, the app tile portion 340 may include app tiles of apps for implementing network resource management, the app tile portion 340 including one of a horizontal listing (not shown), a vertical listing (not shown), or a grid-array or grid listing (as shown in FIG. 3A) of apps as app tiles, or the like.

In some embodiments, the apps for implementing network resource management may include at least one of an auction-based exchange system app 340a corresponding to the auction-based exchange system, a resource reservation system 340b corresponding to the resource reservation system, a resource trading system 340c corresponding to the resource trading system, a resource resale system 340d corresponding to the resource resale system, and/or a resource sub-leasing system 340e corresponding to the resource sub-leasing system, and/or the like. As shown, e.g., in FIG. 3A, the apps 340a, 340b, 340c, and 340d-340e may be published or provided by Service Providers 1, 2, 3, and 4, respectively. In some cases, one of Service Providers 1-4 may be the network service provider that also provides the user or entity with network services (e.g., Internet services, or the like). In some instances, two or more of the Service Providers 1-4 may be the same service provider. In some examples, Service Providers 1-4 may be a single service provider.

With reference to example UI 300B of FIG. 3B, the auction-based exchange system app 340a and/or the underlying auction-based exchange system (e.g., auction-based exchange system 105b of FIG. 1, or the like) may be configured to coordinate and provide UI functionality to enable the first entity (e.g., an entity among the one or more entities 120a-120n, or the like) to select, and make available for auction, an amount of (and what type(s) of) unused network resources (e.g., network resources 135 including one or more compute resources 140a-140x and 205a, network component resources 145a-145y and 210a, and/or data storage resources 150a-150z and 215a, or the like) that is assigned and provisioned to that entity (such as network resources 205b, 210b, and 215b of FIGS. 2A and 2B, or the like) and to provide a starting bid. As shown, e.g., in the non-limiting example of FIG. 3B, UI 300B may display or present the total, used, and unused amounts, in this case, 120 compute units (“CUs”) [total], 33% [used], and 67% [unused] for the compute resources; 100 network component units (“NUs”) [total], 54% [used], and 46% [unused] for the network component resources; and 80 storage units (“SUs”) [total], 40% [used], and 60% [unused] for the data storage resources that are assigned and provisioned to Entity *******01. As used herein, CU, NU, and SU may refer to discrete units of physical or virtual network resources that each either represents the smallest component that is capable of performing its corresponding task (e.g., CU for a component that is capable of performing compute tasks, NU for a component that is capable of performing network tasks, and SU for a component that is capable of performing data storage tasks, and so on) or represents a standard sized or industry-agreed-upon component that is capable of performing its corresponding task. In some examples, UI 300B may also display or present input fields for the first entity to input or enter the amount of each type of network resource to make available for auction and the corresponding starting bid, in this case, 50% [amount for auction] and $ CC per CU [starting bid] for the compute resources; 30% [amount for auction] and $ NN per NU [starting bid] for the network component resources; and 40% [amount for auction] and $ SS per SU [starting bid] for the data storage resources. Although percentage values are used to denote used and unused amounts of network resources as well as amounts for auction, actual numbers of units (e.g., CU, NU, and SU) may alternatively or additionally be used. Herein, CC, NN, and SS represent dollar values per unit for the corresponding type of network resources, and may be the same or different as each other.

Referring to example UI 300C of FIG. 3C, the auction-based exchange system app 340a and/or the underlying auction-based exchange system may further provide UI functionality to enable the second entity (e.g., any one or more of the other entities among the one or more entities 120a-120n, or the like) to display or present the amount of (each type of) network resource available for bidding from Entity *******01, to input or indicate how much (and which type(s)) of the available unused network resources to request and bid upon, and to enter bids (not shown) until a final bid has been entered, in this case, 60 CUs [amount available for auction], 50 CUs [amount requested], and $ XXX per CU [final bid] for the compute resources; 30 NUs [amount available for auction], 20 NUs [amount requested], and $ YYY per NU [final bid] for the network component resources; and 32 SUs [amount available for auction], 25 SUs [amount requested], and $ ZZZ per SU [final bid] for the data storage resources. After the final bids have been entered and the bidding process has closed, the UI functionality provides an indication as to whether the final bid by the entity (in this case, Entity *******02) and the bidding process is successful, in this case, successful for bidding on the compute resources and the network component resources, but unsuccessful for bidding on the data storage resources.

With reference to example UI 300D of FIG. 3D, the network resource reservation system app 340b and/or the underlying network resource reservation system (e.g., network resource reservation system 105c of FIG. 1, or the like) may be configured to coordinate and provide UI functionality to enable the first entity (e.g., an entity among the one or more entities 120a-120n, or the like) to select, and make available for reservation (by other entities), an amount of (and what type(s) of) unused network resources (e.g., network resources 135 including one or more compute resources 140a-140x and 205a, network component resources 145a-145y and 210a, and/or data storage resources 150a-150z and 215a, or the like) that is assigned and provisioned to that entity (such as network resources 205b, 210b, and 215b of FIGS. 2A and 2B, or the like) and to provide a price point. As shown, e.g., in the non-limiting example of FIG. 3D, UI 300D may display or present the total, used, and unused amounts, in this case, 120 CUs [total], 33% [used], and 67% [unused] for the compute resources; 100 NUs [total], 54% [used], and 46% [unused] for the network component resources; and 80 SUs [total], 40% [used], and 60% [unused] for the data storage resources that are assigned and provisioned to Entity *******01. In some examples, UI 300D may also display or present input fields for the first entity to input or enter the amount of each type of network resource to make available for reservation (by other entities) and the corresponding price point, in this case, 50% [amount to make available for reservation] and $ CCC per CU [price point] for the compute resources; 30% [amount to make available for reservation] and $ NNN per NU [price point] for the network component resources; and 40% [amount to make available for reservation] and $ SSS per SU [price point] for the data storage resources. Although percentage values are used to denote used and unused amounts of network resources as well as amounts to make available for reservation, actual numbers of units (e.g., CU, NU, and SU) may alternatively or additionally be used. Herein, CCC, NNN, and SSS represent dollar values per unit for the corresponding type of network resources, and may be the same or different as each other.

Referring to example UI 300E of FIG. 3E, the network resource reservation system app 340b and/or the underlying network resource reservation system may further provide UI functionality to enable the second entity (e.g., any one or more of the other entities among the one or more entities 120a-120n, or the like) to display or present the amount of (each type of) network resource available for bidding from Entity *******01, to input or indicate how much (and which type(s)) of the available unused network resources to request and bid upon, to indicate the cost based on the price point and the amount requested, and to input or enter a reservation period, in this case, 60 CUs [amount available for reservation], 50 CUs [amount requested], $50CCC (or 50×$ CCC) [cost], and 3 months [reservation period] for the compute resources; 30 NUs [amount available for reservation], 20 NUs [amount requested], $20NNN (or 20×$ NNN) [cost], and 2 months [reservation period] for the network component resources; and 32 SUs [amount available for reservation], 25 SUs [amount requested], and $25SSS (or 25×$ SSS) [cost], and 4 months [reservation period] for the data storage resources. After the reservation has been processed, the UI functionality provides an indication as to whether the reservation requested by the entity (in this case, Entity *******02) is successful, in this case, successful for reserving each of the compute resources, the network component resources, and the data storage resources.

With reference to example UI 300F of FIG. 3F, the network resource trading system app 340c and/or the underlying network resource trading system (e.g., network resource trading system 105d of FIG. 1, or the like) may be configured to coordinate and provide UI functionality to enable the first entity (e.g., an entity among the one or more entities 120a-120n, or the like) to select, and make available for trading, an amount of (and what type(s) of) unused network resources (e.g., network resources 135 including one or more compute resources 140a-140x and 205a, network component resources 145a-145y and 210a, and/or data storage resources 150a-150z and 215a, or the like) that is assigned and provisioned to that entity (such as network resources 205b, 210b, and 215b of FIGS. 2A and 2B, or the like). As shown, e.g., in the non-limiting example of FIG. 3F, UI 300F may display or present the total, used, and unused amounts, in this case, 120 CUs [total], 33% [used], and 67% [unused] for the compute resources; 100 NUs [total], 54% [used], and 46% [unused] for the network component resources; and 80 SUs [total], 40% [used], and 60% [unused] for the data storage resources that are assigned and provisioned to Entity *******01. In some examples, UI 300F may also display or present input fields for the first entity to input or enter the amount of each type of network resource to make available for trading, to input or enter information for network resources requested for trade, to input or enter an amount of network resources requested, and to input or enter a period requested for the requested network resources, in this case, 50% [amount for trading] for the compute resources; 30% [amount for trading] for the network component resources; 40% [amount for trading] for the data storage resources; and “RRRRRRRRRRRRR” [network resources requested for the trade], 75 resource units (“RUs”) [amount of requested network resources], and 4 months [period requested]. Although percentage values are used to denote used and unused amounts of network resources as well as amounts for trading, actual numbers of units (e.g., CU, NU, and SU) may alternatively or additionally be used. Herein, RRRRRRRRRRRRR represents at least one of a string value, an alphanumeric value, or a text value representing the information for the network resources requested for trade. Herein, RUs may refer to one of CUs, NUs, SUs, or a unit corresponding to a combination of two or more of CUs, NUs, and SUs (e.g., RUs may represent a total number of such different units). In some cases, where different types of network resources are used, the UI 300F may provide input fields for the first entity to input or enter the information and amount for each type of network resource (not shown).

Referring to example UI 300G of FIG. 3G, the network resource trading system app 340c and/or the underlying network resource trading system may further provide UI functionality to enable the second entity (e.g., any one or more of the other entities among the one or more entities 120a-120n, or the like) to display or present the amount of (each type of) network resource available for trading from Entity *******01, to input or indicate how much (and which type(s)) of the available unused network resources to request in the trade, and to input or enter a trading period for the requested network resources, in this case, 60 CUs [amount available for trading], 50 CUs [amount requested], and 4 months [trading period] for the compute resources; 30 NUs [amount available for trading], 20 NUs [amount requested], and 4 months [trading period] for the network component resources; and 32 SUs [amount available for trading], 25 SUs [amount requested], and 4 months [trading period] for the data storage resources. In some examples, UI 300G may also display or present the network resources requested by Entity *******01 that are available for trade by Entity *******02 [in this case, network resources “RRRRRRRRRRRRR” ], amount of said network resources available for trade by Entity *******02 [in this case, 80 RUs, with 75 RUs to be traded, per the amount requested by Entity *******01]. Like with UI 300F, where different types of network resources are used, the UI 300G may provide display fields for indicating the information and amount for each type of network resource (not shown). In examples, UI 300G may further display or present a value of the requested resources [in this case, $ AAAAA], a value of the available resources [in this case, $ BBBBB], and a difference in value between the requested resources and the available resources [in this case, +$ DDDD], where a positive value (i.e., $ AAAAA being greater than $ BBBBB) indicates that Entity *******02 must pay for the requested network resources (i.e., 50 CUs, 20 NUs, and 25 SUs for 4 months each) despite trading 75 RUs of network resources “RRRRRRRRRRRRR,” while a negative value (i.e., $ BBBBB being greater than $ AAAAA) indicates that Entity *******02 will receive monetary value for trading 75 RUs of network resources “RRRRRRRRRRRRR” despite receiving the requested network resources (i.e., 50 CUs, 20 NUs, and 25 SUs for 4 months each).

With reference to example UI 300H of FIG. 3H, the network resource resale system app 340d and/or the underlying network resource resale system (e.g., network resource resale system 105e of FIG. 1, or the like) may be configured to coordinate and provide UI functionality to enable the first entity (e.g., an entity among the one or more entities 120a-120n, or the like) to select, and make available for resale, an amount of (and what type(s) of) unused network resources (e.g., network resources 135 including one or more compute resources 140a-140x and 205a, network component resources 145a-145y and 210a, and/or data storage resources 150a-150z and 215a, or the like) that is assigned and provisioned to that entity (such as network resources 205b, 210b, and 215b of FIGS. 2A and 2B, or the like) and to provide a sale (or resale) price. As shown, e.g., in the non-limiting example of FIG. 3H, UI 300H may display or present the total, used, and unused amounts, in this case, 120 CUs [total], 33% [used], and 67% [unused] for the compute resources; 100 NUs [total], 54% [used], and 46% [unused] for the network component resources; and 80 SUs [total], 40% [used], and 60% [unused] for the data storage resources that are assigned and provisioned to Entity *******01. In some examples, UI 300H may also display or present input fields for the first entity to input or enter the amount of each type of network resource to make available for resale and the corresponding sale price, in this case, 50% [amount for resale] and $ CCC per CU [sale price] for the compute resources; 30% [amount for resale] and $ NNN per NU [sale price] for the network component resources; and 40% [amount for resale] and $ SSS per SU [sale price] for the data storage resources. Although percentage values are used to denote used and unused amounts of network resources as well as amounts for resale, actual numbers of units (e.g., CU, NU, and SU) may alternatively or additionally be used. Herein, CCC, NNN, and SSS represent dollar values per unit for the corresponding type of network resources, and may be the same or different as each other.

Referring to example UI 300I of FIG. 3I, the network resource resale system app 340d and/or the underlying network resource resale system may further provide UI functionality to enable the second entity (e.g., any one or more of the other entities among the one or more entities 120a-120n, or the like) to display or present the amount of (each type of) network resource available for resale from Entity *******01, to input or indicate how much (and which type(s)) of the available unused network resources to request and purchase, and to indicate the cost based on the sale price, in this case, 60 CUs [amount available for resale], 50 CUs [amount requested], and $50CCC (or 50×$ CCC) [cost] for the compute resources; 30 NUs [amount available for resale], 20 NUs [amount requested], and $20NNN (or 20×$ NNN) [cost] for the network component resources; and 32 SUs [amount available for resale], 25 SUs [amount requested], and $25SSS (or 25×$ SSS) [cost] for the data storage resources. After the costs have been entered and the resale process has closed, the UI functionality provides an indication as to whether the resale process is successful for the purchasing entity (in this case, Entity *******02), in this case, successful for purchasing each of the compute resources, the network component resources, and the data storage resources.

With reference to example UI 300J of FIG. 3J, the network resource sub-leasing system app 340e and/or the underlying network resource sub-leasing system (e.g., network resource sub-leasing system 105f of FIG. 1, or the like) may be configured to coordinate and provide UI functionality to enable the first entity (e.g., an entity among the one or more entities 120a-120n, or the like) to select, and make available for sub-leasing, an amount of (and what type(s) of) unused network resources (e.g., network resources 135 including one or more compute resources 140a-140x and 205a, network component resources 145a-145y and 210a, and/or data storage resources 150a-150z and 215a, or the like) that is assigned and provisioned to that entity (such as network resources 205b, 210b, and 215b of FIGS. 2A and 2B, or the like) and to provide a lease (or sub-lease) price and a lease (or sub-lease) period. As shown, e.g., in the non-limiting example of FIG. 3J, UI 300J may display or present the total, used, and unused amounts, in this case, 120 CUs [total], 33% [used], and 67% [unused] for the compute resources; 100 NUs [total], 54% [used], and 46% [unused] for the network component resources; and 80 SUs [total], 40% [used], and 60% [unused] for the data storage resources that are assigned and provisioned to Entity *******01. In some examples, UI 300J may also display or present input fields for the first entity to input or enter the amount of each type of network resource to make available for sub-leasing and the corresponding lease price and lease period, in this case, 50% [amount for sub-leasing], $ CCC per CU [lease price], and 3 months [lease period] for the compute resources; 30% [amount for sub-leasing], $ NNN per NU [lease price], and 3 months [lease period] for the network component resources; and 40% [amount for sub-leasing], $ SSS per SU [lease price], and 3 months [lease period] for the data storage resources. Although percentage values are used to denote used and unused amounts of network resources as well as amounts for sub-leasing, actual numbers of units (e.g., CU, NU, and SU) may alternatively or additionally be used. Herein, CCC, NNN, and SSS represent dollar values per unit for the corresponding type of network resources, and may be the same or different as each other.

Referring to example UI 300K of FIG. 3K, the network resource sub-leasing system app 340e and/or the underlying network resource sub-leasing system may further provide UI functionality to enable the second entity (e.g., any one or more of the other entities among the one or more entities 120a-120n, or the like) to display or present the amount of (each type of) network resource available for sub-leasing from Entity *******01, to input or indicate how much (and which type(s)) of the available unused network resources to request for sub-leasing, and to indicate the cost based on the lease (or sub-lease) price and the lease (or sub-lease)s period, in this case, 60 CUs [amount available for sub-leasing], 50 CUs [amount requested], $50CCC (or 50×$ CCC) [lease price], and 3 months [lease period] for the compute resources; 30 NUs [amount available for sub-leasing], 20 NUs [amount requested], $20NNN (or 20×$ NNN) [lease price], and 3 months [lease period] for the network component resources; and 32 SUs [amount available for sub-leasing], 25 SUs [amount requested], $25SSS (or 25×$ SSS) [lease price], and 3 months [lease period] for the data storage resources. After the lease prices have been entered and the sub-leasing process has closed, the UI functionality provides an indication as to whether the sub-leasing process is successful for the entity (in this case, Entity *******02), in this case, successful for sub-leasing each of the compute resources, the network component resources, and the data storage resources.

In some aspects, although not shown in UIs 300B, 300D, 300F, 300H, and 300J of FIGS. 3B, 3D, 3F, 3H, and 3J, the first UI may further provide management options for the first entity to manage scheduling unused capacity for at least one of auction, reservation, trade, resale, or sub-lease, and/or the like. Herein, “*” in FIG. 3 represents redacted information, but would be visible to a user during regular use of the capacity on demand broker system UI(s) (unless otherwise indicated). In some embodiments, providing management options to manage scheduling based on at least one of high or low watermarks within available resources among the identified first set of network resources. As used herein, high watermark may refer to an upper percentage of network resources (e.g., total network resources assigned and provisioned to the first entity, total unused network resources among said total network, or total available unused network resources among said total unused network resources, or the like) that, when reached, automatically starts a process for triggering initiation of one or more of the auction process, the reservation process, the trading process, the resale process, or sub-leasing process (collectively, “brokering process(es)”) for the unused capacity, or automatically starts scheduling the brokering process(es). As used herein, low watermark may refer to a lower percentage of the network resources (e.g., total network resources assigned and provisioned to the first entity, total unused network resources among said total network, or total available unused network resources among said total unused network resources, or the like) that, when reached, automatically stops, mitigates, or prevents the process for triggering initiation of the brokering process(es) for the unused capacity, or automatically stops, mitigates, or prevents scheduling the brokering process(es). In some instances, the management options may include calendar-based scheduling management functionalities. The calendar-based scheduling also takes into account specified periods for re-assignment and re-provisioning of the network resources starting or ending, resulting in updating of the calendar-based scheduling.

In some aspects, the computing system (e.g., a capacity on demand broker system, or the like) provides features to support at least one of a reservation or booking system within an edge orchestrator of a service provider for managing edge resources, an auction or bidding exchange system where the service provider sells unused edge resources, an auction or exchange system for customers to securely transfer ownership of specific periods (e.g., minutes, hours, months, etc.) of purchased resources to other customers of the service provider and future integration with composable disaggregated infrastructure systems. In some examples, the edge orchestrator is configured to allow for customers to schedule reservations against specific edge compute resources, specific edge network component resources, and/or specific edge data storage resources (collectively, “network resources”), or the like. In examples, the auction or exchange system is configured to allow customers to resell or trade reserved network resources with other customers. The exchange could be based on digital ledger technologies and may be rendered or minted similar to non-fungible assets or tokens. In some embodiments, composable disaggregated infrastructure resources may be integrated into reservation systems and/or auction or exchange systems to allow specific components that make up a bare metal machine to be utilized as network resources within auction or exchange systems, or the like. According to some embodiments, ultra long haul and/or metro fiber services or resources may be integrated into the reservation systems and/or bidding or exchange systems (in some cases, via optical transport and Ethernet access).

In some examples, the computing system enables customers to participate in a dynamic capacity on demand community exchange by providing a reservation feature within the edge orchestrator to allow customers to define specific date and/or time (e.g., by minute, hour, or month) to reserve edge compute resources, private Ethernet and/or dedicated Internet access network products (or edge network component resources), and edge network storage blocks and/or object-based storage products, and/or the like. In some cases, the computing system enables reservation of edge compute servers based on defined time slots allocated by hourly blocks and based on availability within the defined period or window provided by the customer. In some instances, the computing system enables reservation of edge network component resources based on connectivity requirements based on public or private networking offerings, in some cases, using intra-edge site development to consume existing dedicated Internet access and Ethernet or multiprotocol label switching (“MPLS”) and/or virtual routing and forwarding (“VRF”) based access product offerings. In examples, the computing system enable reservation of network storage resources based on private and public based blocks and/or object storage product offerings. In some cases, customers could be offered an option to store data elements “offline” at a lower rate to allow for positioning of various assets and an ability to quickly make data stored available for “online” use.

In some embodiments, the computing system enables bidding and/or auction feature internal to the capacity on demand broker system. Service providers encounter periods of time where not all network resources at a particular site are allocated for use by a customer. The service provider may set pricing on edge compute resources, edge network component resources, and/or edge data storage resources at a fixed-price model not taking advantage of increased rates that could be charged during times of increased usage to support a plethora of internal and external events. In some cases, the internal events may include at least one of historical prices, a location of an edge site, a number of servers, flavors of servers, features provided, services provided, or demand fluctuations based on seasonality and holidays, and/or the like. In some instances, the external events may include at least one of pricing strategies of competitors, economic changes, live events, exchange rates, political situations, or unplanned events and/or disasters, and/or the like. In some examples, the computing system may reduce risks to customers of encountering sold-out conditions during their specific scheduling needs of edge network resources. The customer manages schedules and scheduling to offer their unused capacity within an auction house or exchange or could be based on high/low watermarks within their available resources.

According to some embodiments, the computing system may also integrate composable disaggregated infrastructure. In some instances, composability allows for hardware components within bare metal servers to be defined at the time of system build. Examples may include GPUs, NVMe, FPGAs, NICs, and/or other types of peripheral component interconnect (“PCI”)-based products and/or services. Some components may be attached over non-PCI fabrics such as other Ethernet and other types of composable fabrics. In some examples, integration with composable orchestration systems may enable hardware components to be broken down independently from processors and memory within the auction house or exchange and may allow customers to “right size” around their workload needs. In examples, breaking down to this level of resource object may allow for the service provider and customers within the reservation, auction house or exchange to reserve specific hardware within an edge site to either use or resell within the auction house or exchange systems. In some cases, the computing system may reduce risks to customers of encountering sold-out conditions during their specific scheduling needs of resources. In some examples, the customer may manage schedules to sub-lease their unused capacity or this could be based on high/low watermarks within their available resources.

In some examples, the computing system may provide Ethernet access integration with edge orchestration, automation, reservation, and/or auction or exchange systems. In some instances, several use cases for edge network resources to involve integrating private networking technologies over Ethernet to enable customers to connect to other distributed operating technology and information technology. According to some embodiments, medium and large-scale customer networks may traverse multiple network providers. Bidding for off-net capacity could initially be focused on NNI already established with various carriers allowing for customers to reserve QoS treatment of traffic as a resource within capacity on demand systems. In some embodiments, Ethernet services may be utilized for connectivity to 5G network slicing use cases, in which multiplexing of virtualized and independent logical networks may be enabled on the same physical network infrastructure, and each network slice is an isolated end-to-end network tailored to fulfill diverse requirements requested by a particular application. In some cases, mobile network operators may utilize 5G network slicing use cases that leverage the same NNI switches and routers as enterprise customers of the network service provider, and/or the like.

These and other functions of the examples 300A-300K (and their components) are described in greater detail herein with respect to FIGS. 1, 2, 4, and 5.

FIGS. 4A-4C (collectively, “FIG. 4”) depict flow diagrams illustrating an example method 400 for implementing capacity on demand functionality, in accordance with various embodiments. Method 400 of FIG. 4A continues onto FIG. 4B following the circular marker denoted, “A,” and continues onto FIG. 4C following the circular marker denoted, “B.”

In the non-limiting embodiment of FIG. 4A, method 400, at operation 405, may include identifying, by a computing system (e.g., computing system 105 or FIG. 1, or the like), a first set of network resources that are assigned to a first entity. In examples, the network resources (e.g., network resources 135 of FIG. 1, or the like) may include compute resources, network resources, and/or data storage resources (e.g., compute resources 140a-140x, network component resources 145a-145y, or data storage resources 150a-150z of FIG. 1, and/or the like). At operation 410, method 400 may include monitoring, by the computing system, usage of the first set of network resources, in some cases, using a monitoring system (e.g., monitoring system 155 of FIG. 1, or the like). Method 400 may further include, at operation 415, generating, by the computing system, a first UI (e.g., UI(s) 125, 300B, 300D, 300F, 300H, and 300J of FIGS. 1, 3B, 3D, 3F, 3H, and 3J) based on the identified first set of network resources and the monitored usage of the first set of network resources. Method 400 may further include presenting, by the computing system, the first UI to the first entity over a first network, the first UI displaying first data regarding the identified first set of network resources and displaying second data regarding an amount of the identified first set of network resources that is unused (at operation 420). At operation 425, method 400 may include presenting, by the computing system, first options in the first UI for the first entity to select and allocate a second set of network resources for use by other entities, the second set of network resources including at least a portion of the unused network resources among the identified first set of network resources. Method 400 may further include, at operation 430, receiving, by the computing system, user input indicating selection and allocation of the second set of network resources, based on selection from the first options in the first UI. Method 400 may continue onto the process at operation 445, following the processes at operations 435 and 440.

Concurrent with (or in parallel with) the processes at operations 405-430, method 400, at operation 435, may include presenting, by the computing system, a second UI (e.g., UI(s) 125, 300C, 300E, 300G, 300I, and 300K of FIGS. 1, 3C, 3E, 3G, 3I, and 3K, or the like) to a second entity over a second network, the second UI displaying second options for the second entity to request provisioning of network resources for specified periods. In some cases, the first network and the second network may be separate networks (e.g., network(s) 170 of FIG. 1, or the like). In some cases, the first network and the second network may be the same network (e.g., one of network(s) 170a-170d of FIG. 1, or the like) or may be overlapping networks (e.g., network(s) 170a-170d of FIG. 1, or the like). Method 400, at operation 440, may include receiving, by the computing system and from the second entity via the second UI, a request for network resources to be provisioned for a specified period. In some cases, the specified period includes at least one of a specified date, a specified time, or a specified duration, and/or the like.

After receiving the user input indicating selection and allocation of the second set of network resources (at operation 430) and after receiving the request for network resources to be provisioned for the specified period (at operation 440), method 400 may further include, at operation 445, determining, by the computing system, whether the second set of network resources satisfies at least a portion of the requested network resources. Based on a determination that at least a portion the second set of network resources satisfies at least a portion of the requested network resources, method 400 may further include re-assigning, by the computing system, the at least a portion of the second set of network resources as a third set of network resources to the second entity for the specified period (at operation 450); and re-provisioning a portion of the first set of network resources corresponding to the third set of network resources to the second entity for the specified period (at operation 455). Method 400 either may continue on the process at operation 460 in FIG. 4B, following the circular marker denoted, “A,” or may continue on the process at operation 470 in FIG. 4C, following the circular marker denoted, “B.”

At operation 460 in FIG. 4B (following the circular marker denoted, “A,” in FIG. 4A), method 400 may include updating, by the computing system, the first UI to present an amount of network resources among the identified first set of network resources available for use after re-assigning to the second entity. Method 400, at operation 465, may include presenting, by the computing system, the updated first UI to the first user.

At operation 470 in FIG. 4C (following the circular marker denoted, “B,” in FIG. 4A), method 400 may include after the specified period, performing the following tasks: re-assigning, by the computing system, the portion of the first set of network resources corresponding to the third set of network resources to the first entity (at operation 475); re-provisioning, by the computing system, the re-assigned portion of the first set of network resources (at operation 480); updating, by the computing system, the first UI to present an amount of network resources among the identified first set of network resources available for use after re-assigning the portion of the first set of network resources back to the first entity (at operation 485); and presenting, by the computing system, the updated first UI to the first entity (at operation 490).

FIG. 5 depicts a flow diagram illustrating another example method 500 for implementing capacity on demand functionality, in accordance with various embodiments. In the non-limiting embodiment of FIG. 5A, method 500, at operation 505, may include providing, by a computing system, a UI (e.g., UI(s) 125 and 300A-300K of FIGS. 1 and 3A-3K, or the like) to each user among a plurality of users (e.g., one or more entities 120a-120n of FIG. 1, or the like), the UI displaying options for auction, reservation, trading, reselling, or sub-leasing of unused capacity in the form of unused network resources (e.g., available unused compute resources 205b, available unused network component resources 210b, and/or available unused data storage resources 215b, and/or the like). At operation 510, method 500 may include brokering, by the computing system, exchanges of unused network resources among two or more users among the plurality of users (as shown, e.g., in UIs 300A-300K of FIGS. 3A-3K, or the like). Method 500 may include re-assigning and re-provisioning, by the computing system, the exchanged unused network resources based on the brokering (at operation 515). Method 500 may further include, at operation 520, updating, by the computing system, a distributed ledger system (e.g., distributed ledger system 160 of FIG. 1, or the like) with transactions based on at least one of the brokered transactions or re-assignment and re-provisioning of the exchanged unused network resources.

While the techniques and procedures are depicted and/or described in a certain order for purposes of illustration, it should be appreciated that certain procedures may be reordered and/or omitted within the scope of various embodiments. Moreover, while the methods 400 and 500 illustrated by FIGS. 4 and 5, respectively, can be implemented by or with (and, in some cases, are described below with respect to) the systems, examples, or embodiments 100, 200A, 200B, and 300A-300K of FIGS. 1, 2A, 2B, and 3A-3K, respectively (or components thereof), such methods may also be implemented using any suitable hardware (or software) implementation. Similarly, while each of the systems, examples, or embodiments 100, 200A, 200B, and 300A-300K of FIGS. 1, 2A, 2B, and 3A-3K, respectively (or components thereof), can operate according to the methods 400 and 500 illustrated by FIGS. 4 and 5, respectively (e.g., by executing instructions embodied on a computer readable medium), the systems, examples, or embodiments 100, 200A, 200B, and 300A-300K of FIGS. 1, 2A, 2B, and 3A-3K can each also operate according to other modes of operation and/or perform other suitable procedures.

### Exemplary System and Hardware Implementation

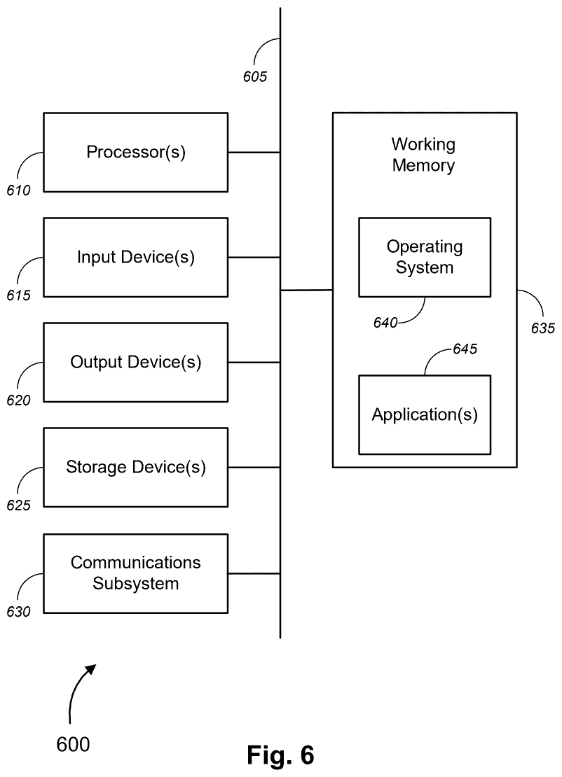

FIG. 6 is a block diagram illustrating an exemplary computer or system hardware architecture, in accordance with various embodiments. FIG. 6 provides a schematic illustration of one embodiment of a computer system 600 of the service provider system hardware that can perform the methods provided by various other embodiments, as described herein, and/or can perform the functions of computer or hardware system (i.e., the computing system 105, the orchestrator 105a, the auction-based exchange system 105b, the resource reservation system 105c, the resource trading system 105d, the resource resale system 105e, the resource sub-leasing system 105f, and the monitoring system 155, etc.), as described above. It should be noted that FIG. 6 is meant only to provide a generalized illustration of various components, of which one or more (or none) of each may be utilized as appropriate. FIG. 6, therefore, broadly illustrates how individual system elements may be implemented in a relatively separated or relatively more integrated manner.

The computer or hardware system 600—which might represent an embodiment of the computer or hardware system (i.e., the computing system 105, the orchestrator 105a, the auction-based exchange system 105b, the resource reservation system 105c, the resource trading system 105d, the resource resale system 105e, the resource sub-leasing system 105f, and the monitoring system 155, etc.), described above with respect to FIGS. 1-5—is shown including hardware elements that can be electrically coupled via a bus 605 (or may otherwise be in communication, as appropriate). The hardware elements may include one or more processors 610, including one or more general-purpose processors and/or one or more special-purpose processors (such as microprocessors, digital signal processing chips, graphics acceleration processors, and/or the like); one or more input devices 615, which can include a mouse, a keyboard, and/or the like; and one or more output devices 620, which can include a display device, a printer, and/or the like.

The computer or hardware system 600 may further include (and/or be in communication with) one or more storage devices 625, which can include local and/or network accessible storage, and/or can include a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including various file systems, database structures, and/or the like.

The computer or hardware system 600 might also include a communications subsystem 630, which can include a modem, a network card (wireless or wired), an infra-red communication device, a wireless communication device and/or chipset (such as a Bluetooth™ device, an 802.11 device, a Wi-Fi device, a WiMAX device, a wireless wide area network (“WWAN”) device, cellular communication facilities, etc.), and/or the like. The communications subsystem 630 may permit data to be exchanged with a network (such as the network described below, to name one example), with other computer or hardware systems, and/or with any other devices described herein. In many embodiments, the computer or hardware system 600 will further include a working memory 635, which can include a RAM or ROM device, as described above.

The computer or hardware system 600 also may include software elements, shown as being currently located within the working memory 635, including an operating system 640, device drivers, executable libraries, and/or other code, such as one or more application programs 645, which may include computer programs provided by various embodiments (including hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 625 described above. In some cases, the storage medium might be incorporated within a computer system, such as the system 600. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 600 and/or might take the form of source and/or installable code, which, upon compilation and/or installation on the computer or hardware system 600 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 600) to perform methods in accordance with various embodiments of the invention. According to a set of embodiments, some or all of the procedures of such methods are performed by the computer or hardware system 600 in response to processor 610 executing one or more sequences of one or more instructions (which might be incorporated into the operating system 640 and/or other code, such as an application program 645) contained in the working memory 635. Such instructions may be read into the working memory 635 from another computer readable medium, such as one or more of the storage device(s) 625. Merely by way of example, execution of the sequences of instructions contained in the working memory 635 might cause the processor(s) 610 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 600, various computer readable media might be involved in providing instructions/code to processor(s) 610 for execution and/or might be used to store and/or carry such instructions/code (e.g., as signals). In many implementations, a computer readable medium is a non-transitory, physical, and/or tangible storage medium. In some embodiments, a computer readable medium may take many forms, including non-volatile media, volatile media, or the like. Non-volatile media includes, for example, optical and/or magnetic disks, such as the storage device(s) 625. Volatile media includes dynamic memory, such as the working memory 635. In some alternative embodiments, a computer readable medium may take the form of transmission media, which includes coaxial cables, copper wire, and fiber optics, including the wires that include the bus 605, as well as the various components of the communication subsystem 630 (and/or the media by which the communications subsystem 630 provides communication with other devices). In an alternative set of embodiments, transmission media can also take the form of waves (including radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 600. These signals, which might be in the form of electromagnetic signals, acoustic signals, optical signals, and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a storage device 625 either before or after execution by the processor(s) 610.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
generating, by a computing system, a first user interface (“UI”);
presenting, by the computing system, the first UI to a first entity over a first network, the first UI displaying first data regarding an identified first set of network resources that is assigned to the first entity and displaying second data regarding an amount of the identified first set of network resources that is unused;
presenting, by the computing system, first options in the first UI for the first entity to select and allocate a second set of network resources for use by other entities, the second set of network resources comprising at least a portion of the unused network resources among the identified first set of network resources;
receiving, by the computing system, user input indicating selection and allocation of the second set of network resources, based on selection from the first options in the first UI;
receiving, by the computing system and from the second entity, a request for network resources to be provisioned for a specified period;
based on a determination that at least a portion of the second set of network resources satisfies at least a portion of the requested network resources, re-assigning, by the computing system, the at least a portion of the second set of network resources as a third set of network resources to the second entity for the specified period; and
re-provisioning a portion of the first set of network resources corresponding to the third set of network resources to the second entity for the specified period.

2. The method of claim 1, wherein the identified first set of network resources, the second set of network resources, and the third set of network resources comprise at least one of compute resources, network component resources, or data storage resources.

3. The method of claim 1, wherein the identified first set of network resources, the second set of network resources, and the third set of network resources comprise at least one of network edge resources, bare metal resources, optical transport resources, network-to-network interconnect (“NNI”) resources, quality of service (“QoS”) monitoring resources, Ethernet access resources, Internet access resources, data storage resources, or composable disaggregated infrastructure resources, wherein the composable disaggregated infrastructure resources comprise at least one of graphics processing units (“GPUs”), non-volatile memory express (“NVMe”)-based memory devices, field programmable gate arrays (“FPGAs”), or network interface controller (“NIC”) cards.

4. The method of claim 1, wherein the specified period comprises at least one of a specified date, a specified time, or a specified duration, wherein the specified duration comprises one of a number of minutes, a number of hours, a number of days, a number of weeks, a number of months, or a number of years.

5. The method of claim 1, further comprising:
identifying, by the computing system, the first set of network resources that is assigned to the first entity; and
monitoring, by the computing system, usage of the first set of network resources;
wherein generating the first UI comprises generating, by the computing system, the first UI based on the identified first set of network resources and the monitored usage of the first set of network resources.

6. The method of claim 1, further comprising:
presenting, by the computing system, a second UI to a second entity over a second network, the second UI displaying second options for the second entity to request provisioning of network resources for specified periods;
wherein receiving the request for network resources comprises receiving, by the computing system and from the second entity via the second UI, the request for network resources to be provisioned for the specified period.

7. The method of claim 6, wherein the computing system comprises an auction-based exchange system, wherein selecting and allocating the second set of network resources for use by other entities comprises selecting the second set of network resources to be placed in a multi-user UI system for bidding by a plurality of entities who have access to the multi-user UI system for a chance to acquire access to the selected second set of network resources, wherein the second entity is a winner of the bidding among the plurality of entities and is provided with an opportunity to request, via the second UI that is presented to the second entity, the network resources to be provisioned.

8. The method of claim 6, wherein the computing system comprises a network resource reservation system, wherein selecting and allocating the second set of network resources for use by other entities comprises selecting the second set of network resources to be marked in a multi-user UI system as being available for reservation by one or more of a plurality of entities who have access to the multi-user UI system, wherein the second entity is an entity among the plurality of entities who has been given a right to reserve the selected second set of network resources, and is provided with options to reserve, via the second UI that is presented to the second entity, the at least a portion of the second set of network resources.

9. The method of claim 6, wherein the computing system comprises a network resource trading system, wherein selecting and allocating the second set of network resources for use by other entities comprises selecting the second set of network resources to be marked in a multi-user UI system as being available for trading with one or more of a plurality of entities who have access to the multi-user UI system, wherein the second entity is an entity among the plurality of entities who has been selected by the first entity to trade other network resources for the selected second set of network resources, wherein the first and second UIs display network resources to be traded.

10. The method of claim 1, wherein the first UI further provides management options for the first entity to manage scheduling unused capacity for at least one of auction, reservation, trade, resale, or sub-lease, based on at least one of high or low watermarks within available resources among the identified first set of network resources, wherein the management options comprise calendar-based scheduling management functionalities.

11. The method of claim 1, wherein re-assignment or re-provisioning of the portion of the first set of network resources to the second entity is recorded as a transaction on a distributed ledger system, wherein the transaction is converted into a non-fungible asset or token.

12. The method of claim 11, wherein configuration management is tracked and recorded as transactions on the distributed ledger system.

13. The method of claim 1, further comprising:
updating, by the computing system, the first UI to present an amount of network resources among the identified first set of network resources available for use after re-assigning to the second entity; and
presenting, by the computing system, the updated first UI to the first entity.

14. The method of claim 1, further comprising:
after the specified period, performing the following tasks:
re-assigning, by the computing system, the portion of the first set of network resources corresponding to the third set of network resources to the first entity;
re-provisioning, by the computing system, the re-assigned portion of the first set of network resources;
updating, by the computing system, the first UI to present an amount of network resources among the identified first set of network resources available for use after re-assigning the portion of the first set of network resources back to the first entity; and
presenting, by the computing system, the updated first UI to the first entity.

15. A system, comprising:
a computing system, comprising:
at least one first processor; and
a first non-transitory computer readable medium communicatively coupled to the at least one first processor, the first non-transitory computer readable medium having stored thereon computer software comprising a first set of instructions that, when executed by the at least one first processor, causes the computing system to:
identify a first set of network resources that are assigned to a first entity;
monitor usage of the first set of network resources;
generate a first user interface (“UI”) based on the identified first set of network resources and the monitored usage of the first set of network resources;
present the first UI to the first entity over a first network, the first UI displaying first data regarding the identified first set of network resources and displaying second data regarding an amount of the identified first set of network resources that is unused;
present first options in the first UI for the first entity to select and allocate a second set of network resources for use by other entities, the second set of network resources comprising at least a portion of the unused network resources among the identified first set of network resources;
receive user input indicating selection and allocation of the second set of network resources, based on selection from the first options in the first UI; and
after re-assigning and re-provisioning at least a portion of the second set of network resources to a second entity for a specified period that is set by the second entity, performing the following tasks:
updating the first UI to present an amount of network resources among the identified first set of network resources available for use after re-assigning the at least a portion of the second set of network resources to the second entity for the specified period; and
presenting the updated first UI to the first entity.

16. The system of claim 15, wherein the first UI further provides management options for the first entity to manage scheduling unused capacity for at least one of auction, reservation, trade, resale, or sub-lease, based on at least one of high or low watermarks within available resources among the identified first set of network resources, wherein the management options comprise calendar-based scheduling management functionalities.

17. The system of claim 15, wherein the first set of instructions, when executed by the at least one first processor, further causes the computing system to:
after the specified period, perform the following tasks:
re-assigning the at least a portion of the second set of network resources to the first entity;
re-provisioning the re-assigned at least a portion of the second set of network resources;
updating the first UI to present an amount of network resources among the identified first set of network resources available for use after re-assigning the at least a portion of the second set of network resources back to the first entity; and
presenting the updated first UI to the first entity.

18. A method, comprising:
providing, by a computing system, a user interface (“UI”) to each user among a plurality of users, the UI displaying options for auctioning, reserving, trading, reselling, or sub-leasing unused capacity in the form of unused network resources;
brokering, by the computing system, exchanges of unused network resources among two or more users among the plurality of users;
re-assigning and re-provisioning, by the computing system, the exchanged unused network resources based on the brokering; and
updating, by the computing system, a distributed ledger system with transactions based on at least one of the brokered transactions or re-assignment and re-provisioning of the exchanged unused network resources.

19. The method of claim 18, wherein the computing system comprises at least one of an orchestrator, an auction-based exchange system, a network resource reservation system, a network resource trading system, a network resource resale system, a network resource sub-leasing system, a server, a cloud computing system, or a distributed computing system.

20. The method of claim 18, wherein the unused network resources comprise at least one of compute resources, network component resources, or data storage resources, wherein the compute resources comprise compute-based composable disaggregated infrastructure resources comprising at least one of graphics processing units (“GPUs”) or field programmable gate arrays (“FPGAs”), wherein the network component resources comprise at least one of network edge resources, bare metal resources, optical transport resources, network-to-network interconnect (“NNI”) resources, quality of service (“QoS”) monitoring resources, Ethernet access resources, Internet access resources, or network-based composable disaggregated infrastructure resources, wherein the network-based composable disaggregated infrastructure resources comprise network interface controller (“NIC”) cards, wherein the data storage resources comprise at least one data storage resources or data storage-based composable disaggregated infrastructure resources, wherein the data storage-based composable disaggregated infrastructure resources comprise non-volatile memory express (“NVMe”)-based memory devices.

21. A method, comprising:
identifying, by a computing system, a first set of network resources that are assigned to a first entity;
monitoring, by the computing system, usage of the first set of network resources;
generating, by the computing system, a first user interface (“UI”) based on the identified first set of network resources and the monitored usage of the first set of network resources;
presenting, by the computing system, the first UI to the first entity over a first network, the first UI displaying first data regarding the identified first set of network resources and displaying second data regarding an amount of the identified first set of network resources that is unused;
presenting, by the computing system, first options in the first UI for the first entity to select and allocate a second set of network resources for use by other entities, the second set of network resources comprising at least a portion of the unused network resources among the identified first set of network resources;
receiving, by the computing system, user input indicating selection and allocation of the second set of network resources, based on selection from the first options in the first UI;
presenting, by the computing system, a second UI to a second entity over a second network, the second UI displaying second options for the second entity to request provisioning of network resources for specified periods;
receiving, by the computing system and from the second entity via the second UI, a request for network resources to be provisioned for a specified period;
determining, by the computing system, whether the second set of network resources satisfies at least a portion of the requested network resources;
based on a determination that at least a portion the second set of network resources satisfies at least a portion of the requested network resources, re-assigning, by the computing system, the at least a portion of the second set of network resources as a third set of network resources to the second entity for the specified period;
re-provisioning, by the computing system, a portion of the first set of network resources corresponding to the third set of network resources to the second entity for the specified period;
updating, by the computing system, the first UI to present an amount of network resources among the identified first set of network resources available for use after re-assigning to the second entity; and
presenting, by the computing system, the updated first UI to the first user.
